(19) United States
(12) Patent Application Publication
(10) Pub. No.: US 2026/0105688 A1
(43) Pub. Date: Apr. 16, 2026

(54) PRIVACY PRESERVING VISUAL LOCALIZATION

(71) Applicant: NAVER CORPORATION, Gyeonggi-do (KR)

(72) Inventors: Maxime PIETRANTONI, Claye-Souilly (FR); Gabriela CSURKA KHEDARI, Meylan (FR); Martin HUMENBERGER, Gières (FR); Torsten SATTLER, Praha 13-Stodûlky (CZ)

(73) Assignee: NAVER CORPORATION, Gyeonggi-do (KR)

(21) Appl. No.: 19/419,499

(22) Filed: Dec. 15, 2025

Related U.S. Application Data
(63) Continuation-in-part of application No. 18/541,808, filed on Dec. 15, 2023, now abandoned.
(60) Provisional application No. 63/528,739, filed on Jul. 25, 2023.

(51) Int. Cl. G06T 17/00; G06T 7/10; G06T 7/70; G06T 15/08; G06V 20/70

(52) U.S. Cl. CPC G06T 17/00; G06T 7/10; G06T 7/70; G06T 15/08; G06V 20/70

(57) ABSTRACT

A method for performing privacy-preserving visual localization includes: determining a query segmentation map based on a query image; accessing a privacy preserved scene representation that includes labeled three dimensional (3D) representations of a scene selected from one or more segmentation classes; determining a predicted pose based on a starting pose; generating, from the predicted pose, a predicted segmentation map; and refining the predicted pose after aligning the predicted segmentation map with a query segmentation map. The above may be repeated. The refined predicted pose of the query image is output.

### PRIORITY INFORMATION

This application is a continuation-in-part of U.S. patent application Ser. No. 18/541,808, filed on Dec. 15, 2023; said U.S. patent application Ser. No. 18/541,808, filed on Dec. 15, 2023, claims priority, under 35 USC § 119(e), from U.S. Provisional Patent Application Ser. No. 63/528,739, filed on Jul. 25, 2023. In addition, this application claims the benefit, under 35 USC § 119(e), from U.S. Provisional Patent Application Ser. No. 63/818,519, filed on Jun. 5, 2025. The entire disclosure of each application referenced above is incorporated herein by reference.

### FIELD

The present disclosure relates to systems and methods for determining camera pose and more particularly to systems and methods for determining camera pose while preserving privacy.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Navigating robots are mobile robots that may be trained to navigate environments without colliding with objects during travel. Navigating robots may be trained in the environment in which they will operate or trained to operate regardless of environment.

Navigating robots may be used in various different industries. One example of a navigating robot is a package handler robot that navigates an indoor space (e.g., a warehouse) to move one or more packages to a destination location. Another example of a navigating robot is an autonomous vehicle that navigates an outdoor space (e.g., roadways) to move one or more occupants from a pickup to a destination.

### SUMMARY

In a feature, a method for performing privacy-preserving visual localization may be provided by a computing device, using a two dimensional (2D) query image captured by a camera. The method comprises determining a query segmentation map based on the query image, wherein each pixel of the query segmentation map is associated with one or more likelihoods that it belongs to one or more segmentation classes that are scene-specific and learned in a self-supervised manner. The method further comprises accessing a privacy preserved scene representation that includes labeled three dimensional (3D) representations of a scene selected from the one or more segmentation classes, the privacy preserved scene representation comprising one or more of: (i) a 3D point cloud generated by Structure-from-Motion (SfM), (ii) a neural implicit field including a neural radiance field (NeRF) and/or associated geometric, segmentation and/or feature fields, and (iii) a Gaussian Splatting Feature Field (GSFF) including a plurality of 3D Gaussian primitives. The method further comprises determining a predicted pose based on a starting pose and generating, from the predicted pose, a predicted segmentation map. The method further comprises refining the predicted pose after aligning the predicted segmentation map with the query segmentation map, each of the query segmentation map and the predicted segmentation map including for each pixel one or more likelihoods that it belongs to the one or more segmentation classes, respectively. The method further comprises repeating the generating and the refining until the query segmentation map and the predicted segmentation map converge to within a predefined convergence criterion. The method further comprises outputting the refined predicted pose of the query image captured by the camera using the predicted segmentation map that converged to within the predicted convergence criterion.

In further features, the privacy preserved scene representation may be generated from a set of training images representing the scene using one or more of (i) Structure-from-Motion (SfM) (ii) Neural Radiance Fields (NeRFs) and (iii) Gaussian Splatting Feature Fields (GSFF).

In further features, the method may further comprise generating (i) a global descriptor of the input image, and (ii) global descriptors with pose information of the set of training images representing the scene, each global descriptor aggregating image features into a single descriptor.

In further features, the starting pose may be predicted based on similarities between the global descriptor for the query image and the global descriptors for the set of training images.

In further features, the privacy preserved scene representation may include labeled three dimensional (3D) representations of the scene with texture and/or fine details obscured and from which views of the scene may be rendered.

In further features, when the privacy-preserved scene representation corresponds to the 3D point cloud generated by SfM, the 3D point cloud includes 3D points labeled by the one or more segmentation classes, wherein the one or more segmentation classes are derived in a self-supervised manner using pixel correspondences.

In further features, when the privacy-preserved scene representation corresponds to the neural implicit field, the neural implicit field may comprises a segmentation field module configured to provide segmentation information on the scene in the training images and a geometric field module configured to provide geometric information on the scene. The neural implicit field may be trained using segmentation labels as supervision such that high-frequency texture details are suppressed, and an internal representation of the scene is privacy-preserving. The neural implicit field may comprise a feature field module configured to provide feature information on the scene,

In further features, when the privacy-preserved scene representation corresponds to the GSFF, the GSFF may comprise one or more 3D Gaussian primitives each having a center, a covariance, an opacity and a feature or segmentation label, wherein images are rendered by rasterizing the one or more 3D Gaussian primitives using depth ordering and alpha blending.

In further features, the method for performing privacy-preserving visual localization may comprise accessing global descriptors with pose information of the set of training images representing the scene. The method may further comprise determining the starting pose based on similarities between the global descriptor for the query image and the global descriptors for the training images.

In further features, the query segmentation map may comprise segmentation heatmaps. The global descriptor may be generated by applying a pooling operator to the segmentation heatmaps. Selecting the starting pose may include selecting k images based on similarities between the global descriptor for the query image and global descriptors of the k images, respectively.

In further features, the aligning may be performed using all pixels of the query segmentation map or only a subset of pixels of the query segmentation map.

In further features, the one or more segmentation classes may define a non-injective mapping from RGB pixels or features to labels such that regions of the scene having different texture details share a same segmentation label to suppress retrieval of sensitive visual details.

In further features, the method for performing privacy-preserving visual localization may comprise determining a location in the scene using the refined predicted pose output and performing, with the computing device, one or more tasks using the determined location. The one or more tasks may be tailored to the location and include one or more of an auditory response concerning the location, a delivery to the location, and navigation to the location.

In further features, the computing device may be a robot and/or a virtual assistant.

In another feature, a system is provided that performs visual localization using a two dimensional (2D) query image captured by a camera. The system comprises at least one processor and at least one memory such that executable instructions stored in the at least one memory are configured to cause the at least one processor to determine a query segmentation map based on the query image, such that each pixel of the query segmentation map is associated with one or more likelihoods that it belongs to one or more segmentation classes that are scene-specific and learned in a self-supervised manner. Executable instructions stored in the at least one memory are configured to further cause the at least one processor to access a privacy preserved scene representation that includes labeled three dimensional (3D) representations of a scene selected from one or more segmentation classes, the privacy preserved scene representation comprising one or more of (i) a 3D point cloud generated by Structure-from-Motion (SfM), (ii) a neural implicit field including a neural radiance field (NeRF) and/or associated geometric, segmentation and/or feature fields, and (iii) a Gaussian Splatting Feature Field (GSFF) including a plurality of 3D Gaussian primitives. Executable instructions stored in the at least one memory are configured to further cause the at least one processor to determine a predicted pose based on a starting pose, generate from the predicted pose a predicted segmentation map, and refine the predicted pose after aligning the predicted segmentation map with the query segmentation map, such that each of the query segmentation map and the predicted segmentation map include for each pixel one or more likelihoods that it belongs to the one or more segmentation classes, respectively. Executable instructions stored in the at least one memory are configured to further cause the at least one processor to repeat the generating and the refining until the query segmentation map and the predicted segmentation map converge to within a predefined convergence criterion. Executable instructions stored in the at least one memory are configured to further cause the at least one processor to output the refined predicted pose of the query image captured by the camera using the predicted segmentation map that converged to within the predicted convergence criterion.

In further features, the privacy preserved scene representation may be generated from a set of training images, and wherein the executable instructions stored in the memory are further configured to cause the processor to generate a global descriptor of the input image, and global descriptors with pose information of the set of training images representing the scene, each global descriptor aggregating image features into a single descriptor.

In further features, the starting pose may be predicted based on similarities between the global descriptor for the query image and the global descriptors for the set of training images.

In further features, the refined predicted pose may be a six degrees of freedom (6 DoF) pose.

In further features, the executable instructions stored in the at least one memory are configured to further cause the at least one processor to determine a location in the scene using the refined predicted pose and perform one or more tasks using the determined location. The one or more tasks may be tailored to the location and include one or more of an auditory response concerning the location, a delivery to the location, and navigation to the location.

In another feature, a training system is provided for privacy preserving visual localization. The training system may comprise a pose module configured to receive training images captured using a camera and determine a six degrees of freedom (6 DoF) pose of the camera that captured each of the training images. The training system may further comprise an encoder module including a segmentation module configured to determine at least one segmentation heatmap and at least one global descriptor based on an input image. The training system my comprise a scene-representation module configured to provide a privacy-preserved scene representation of a scene viewed in the training images, the scene-representation module being configured to implement one or more of a 3D point cloud generated by Structure-from-Motion having labeled 3D points, a neural implicit field including a segmentation field module providing segmentation information, a geometric field module providing geometric information, and a a Gaussian Splatting Feature Field including 3D Gaussians each having a center, covariance, opacity, and feature or segmentation label. The training system may further comprise a training module configured to input the training images to the pose module, determine prototype distributions or prototypes in a feature embedding space based on feature maps or volumetric features derived from the training images and the privacy-preserved scene representation, and train at least the segmentation module and at least one of the pose module, the scene-representation module, the segmentation field module, and the geometric field module. The training module may perform the training by alternating between updating a target distribution with parameters of the segmentation module fixed based on minimizing a first loss determined using a label distribution determined from the prototypes, updating parameters of the segmentation module with the target distribution fixed based on minimizing a second loss that is different from the first loss, and updating parameters of the segmentation module and/or the pose module based on a ranking loss using a global representation.

In further features, the second loss may be a per-pixel cross-entropy loss between predicted segmentation heatmaps and pseudo-labels.

In further features, the training module may be configured to train the segmentation module based on a first function based on feature vectors and prototype distributions during a first epoch of a predetermined number of epochs and a second function different from the first function during remaining epochs.

In further features, the training module may be configured to train the pose module further based on minimizing a consistency loss, the consistency loss being determined based on at least one of labels assigned to keypoints in the training images based on distances to the prototype distributions and feature maps determined based on the training images.

In further features, the training module may be further configured to train the segmentation module based on minimizing a contrastive loss determined based on the prototype distributions, feature maps, and concentrations of the prototype distributions.

In further features, the ranking loss may comprise a multi-similarity loss applied to at least one global descriptor derived from the training images.

In further features, the scene-representation module may implement the Gaussian Splatting Feature Field. The training module may be further configured to cause a rasterization module to render a second feature map and a second segmentation map aligned with a first feature map and a first segmentation map extracted by the encoder module. The training module may be further configured to train parameters of the encoder module based on at least one loss determined based on at least one of a difference between the first feature map and the second feature map, and a difference between the first segmentation map and the second segmentation map.

In further features, the training module may be further configured to apply spectral clustering on a Delaunay graph derived from a Gaussian cloud to produce a set of prototypes, and generate labels for respective 3D Gaussians of the Gaussian cloud by assigning volumetric features to the prototypes.

In further features, the scene-representation module may implement the neural implicit field with segmentation. The training module may be configured to generate a first set of K prototypes based on features extracted from an input image and generate a second set of K prototypes based on segmentation information, geometric information, and feature information produced by the segmentation field module, and the geometric field module. The training module may be further configured to align the first and second sets of K prototypes and determine segmentation targets based on mapping features to the prototypes based on similarities in the feature embedding space and jointly train the encoder module, the segmentation field module, and the geometric field module, using a cross-entropy loss based on the segmentation targets. K may be an integer greater than zero and corresponds to a predetermined number of segmentation classes.

In another feature, a training method for privacy-preserving visual localization may be provided that comprises receiving, by a pose module executed by at least one processor, training images captured using a camera. The training method may comprise determining, by an encoder module including a segmentation module executed by the at least one processor, at least one segmentation heatmap and at least one global descriptor based on an input image. The training method may comprise providing, by a scene-representation module executed by the at least one processor, a privacy-preserved scene representation of a scene viewed in the training images. The scene-representation module may implement one or more of a 3D point cloud generated by Structure-from-Motion having labeled 3D points, a neural implicit field including a segmentation field module providing segmentation information and a geometric field module providing geometric information, and a Gaussian Splatting Feature Field including 3D Gaussians each having a center, covariance, opacity, and feature or segmentation label. The training method may comprise determining, by a training module executed by the at least one processor, prototype distributions or prototypes in a feature embedding space based on feature maps or volumetric features derived from the training images and the privacy-preserved scene representation. The training method may comprise training, by the training module, at least the segmentation module and at least one of the pose module, the scene-representation module, the segmentation field module, and the geometric field module. The training may comprise alternating between (i) updating a target distribution with parameters of the segmentation module fixed based on minimizing a first loss determined using a label distribution determined from the prototypes, (ii) updating parameters of the segmentation module with the target distribution fixed based on minimizing a second loss that is different than the first loss, and (iii) updating parameters of the segmentation module and/or the pose module based on a ranking loss using the global descriptor.

In further features, alternating between (i)-(iii) is performed according to a schedule in which a weighting coefficient associated with the first loss decreases over training epochs while a weighting coefficient associated with the ranking loss increases.

In further features, alternating between (i), (ii), and (iii) may include constraining parameters of the pose module using a regularization term penalizing deviation from poses determined from Structure-from-Motion.

In further features, the training method may further comprise augmenting at least one of the training images using at least one augmentation selected from image cropping, color jittering, synthetic noise injection, or geometric warping prior to determining the segmentation heatmap

In further features, the training method may further comprise normalizing feature vectors used to form the prototype distributions using at least one of L2 normalization or batch normalization prior to determining the label distribution.

In further features, determining the prototype distributions may include rejecting outlier feature vectors based on a distance threshold relative to a cluster center associated with one of the prototypes.

In further features, the training method may further comprise storing, in a memory, intermediate prototype distributions generated during earlier epochs and reusing the intermediate prototype distributions for stabilizing later iterations of the training.

In further features, the global descriptor may be determined using a pooling operator applied to the segmentation heatmap that includes at least one of max pooling, average pooling, or generalized mean pooling.

In further features, the training method may include generating confidence values for respective segmentation classes based on distances to respective prototypes or learning, and applying the confidence values during training and inference.

In further features, the training module may be further configured to enforce temporal consistency between segmentation heatmaps generated from sequential training images captured along a visual trajectory.

In further features, the training method may further comprise quantizing at least one segmentation heatmap or feature map to reduce memory used by the scene-representation module during the training.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present disclosure will become more fully understood from the detailed description and the accompanying drawings, wherein:

FIG. 1 is a functional block diagram of an example implementation of a navigating robot;

FIGS. 2A, 2B, and 3 are functional block diagrams of example pose determination systems;

FIG. 4 is a functional block diagram of an example training system;

FIG. 5 includes example pairs of images with 2D-2D correspondences between the images of each pair from the training dataset;

FIG. 6 includes an example illustration of portions of the location and pose module of FIGS. 2A and 2B;

FIG. 7 illustrates example consistency losses;

FIG. 8 includes an algorithm for training the location and pose module used by the training module;

FIG. 9 is a flowchart depicting an example method of determining a refined pose and controlling movement of a robot;

FIG. 10 includes a functional block diagram including a visual localization system;

FIG. 11 includes a functional block diagram of an example of the Gaussian splattering feature fields privacy preserving system;

FIG. 12 includes pseudo code for an example algorithm for training;

FIG. 13 includes four example sets of images;

FIG. 14 includes sets of images;

FIG. 15 includes example graphs of median translation and rotation errors different training datasets against the number of classes of each model;

FIG. 16 illustrates example training for privacy and a ppNeSF system;

FIG. 17 includes a functional block diagram of an example implementation of a ppNeSF system and a training system;

FIGS. 18-19 include example sets of images;

FIG. 20 includes example images and corresponding reconstructions; and

FIG. 21 includes pseudo-code for an example algorithm for training of the ppNeSF module.

In the drawings, reference numbers may be reused to identify similar and/or identical elements.

### DETAILED DESCRIPTION

Visual navigation of mobile robots combines the domains of vision and control. The vision aspect involves image retrieval. Navigation can be described as finding a suitable and non-obstructed path between a starting location and a destination location. A navigating robot includes a control module configured to move the navigating robot based on input from one or more sensors (e.g., cameras) using a trained model.

Visual localization (VL) involves estimating a camera pose including position and orientation from which a captured image was taken in a known scene. Visual localization is used in multiple fields, such as self-driving vehicles, autonomous robots, mixed reality applications, and other fields. VL can be used in visual navigation.

Visual localization may use a three dimensional (3D) scene representation of the target area (the scene), which can be a 3D point cloud map (e.g., from Structure-from-Motion (SfM), a learned 3D representation, LiDAR-based, or from simultaneous localization and mapping algorithms), a voxel grid, a mesh model, a depth map, or a signed distance field (SDF) where each voxel stores the distance to the nearest surface. The representation may be derived from reference images with known camera poses. The representation may be stored remotely or locally depending on the application, which implicate memory consumption and privacy preservation.

Regarding privacy preservation, it may be possible to reconstruct images from maps that contain local image features, which may be used for scene representation. This may decrease privacy regarding features in the image(s).

To increase privacy and decrease memory usage relative to feature-based approaches, the present disclosure involves robust image segmentation where a global image representation for image retrieval may be used along with dense local representations suitable for building a compact 3D map (which, for example, may be an order of magnitude smaller compared to feature-based approaches) and for accurate pose refinement. Using such representations for visual localization leads to robustness, increased privacy, and reduced memory consumption.

The visual localization pipeline may represent the scene via a 3D model. First, image retrieval based on a compact image representation is used to coarsely localize a query image. Given such an initial pose estimate, the camera pose is refined by aligning the query image to the 3D map. A more abstract representation in the form of a robust dense segmentation based on a set of clusters learned in a self-supervised manner is used.

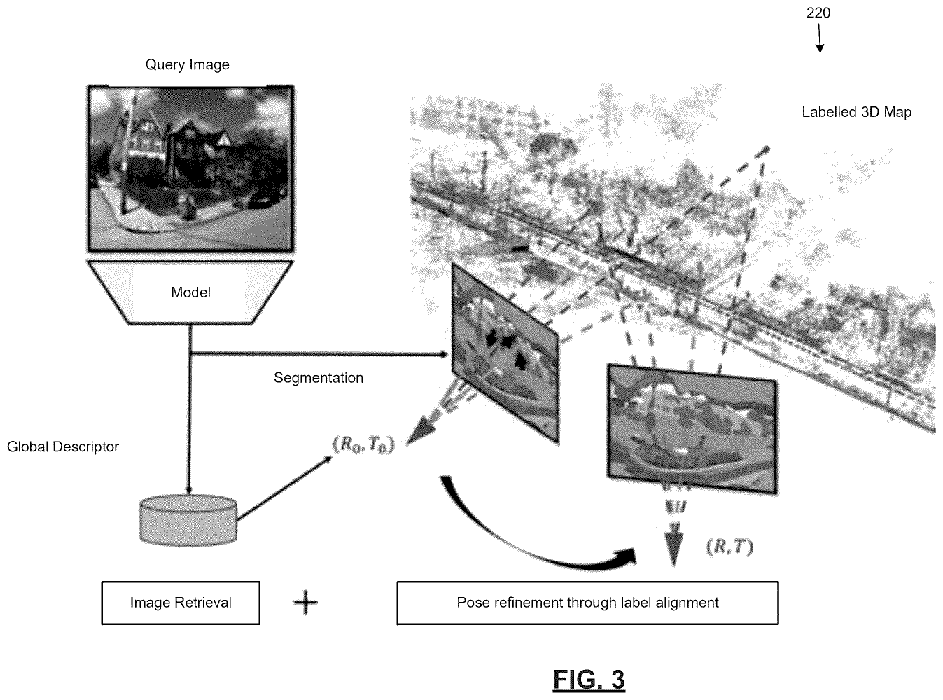

As illustrated in FIG. 3 and as discussed further below, both global descriptors for image retrieval and a dense image representation for pose refinement are derived from the segmentation. The pose refinement is performed by maximizing labeling consistency between the predictions in the query image and a set of labeled 3D points in the scene. Label consistency may be optimized (e.g., maximized) by minimizing the label inconsistency (with regards to the pose) for example by applying cross-entropy loss between the predicted 2D labels (or class probabilities) and the reprojected labels derived from the 3D representation. Such an optimization may be performed for example by using the Levenberg-Marquart algorithm (Equation in SegLoc) or by backpropagation (especially for the rendering based models such as NerF or 3DGS). This has multiple advantages. First, the features described herein provide increased robustness to seasonal or appearance changes in the scene/environment as it depends less on low-level details and more on higher level representations learnt explicitly to be invariant to such variations. Second, it results in low storage requirements, as instead of storing high-dimensional feature descriptors, only a label is stored for each 3D point. Third, the features described herein allow privacy-preserving visual localization as there is created a non-injective mapping from multiple images that show similar objects or object parts with different appearances to similar local/region labels.

Accordingly, robust fine-grained image segmentations are learnt in a self-supervised manner by leveraging discriminative clustering and consistency regularization terms. A model, trained for localization, learns jointly global image representation to retrieve images for pose initialization and dense local representations for building a compact labeled 3D map—an order of magnitude smaller compared to feature-based approaches—and to perform privacy-preserving pose refinement.

There is a connection between segmentation-based representations and privacy-preserving localization, opening up viable alternatives to keypoint-based visual localization methods within the accuracy-privacy-memory trade-off. The proposed visual localization can be used in indoor and outdoor environments. The pose refinement includes estimating the accurate camera pose from its approximate pose by image alignment. Instead of using multi-scale deep features, the present disclosure involves aligning predicted fine-grained segmentation and the corresponding 3D map by minimizing a reprojection error as a function of labeling inconsistency. The refinement may be performed based on a hierarchy of fine-grained segmentations jointly learned with global image representations where from coarser to finer segmentation maps are used leverage information from different levels of granularity. The present disclosure directly optimizes/refines the 6DoF pose.

The present disclosure also describes systems and methods to utilize three dimensional (3D) Gaussian Splatting (3DGS)-based representations for accurate and privacy-preserving visual localization. Gaussian Splatting Feature Fields (GSFFs) may be used, a scene representation for visual localization that combines an explicit geometry model (3DGS) with an implicit feature field. The dense geometric information and a differentiable rasterization algorithm may be used from 3DGS to learn robust feature representations grounded in 3D. The systems and methods may align a 3D scale-aware feature field and a 2D feature encoder in a common embedding space through a contrastive framework.

Using 3D structure-informed clustering, the present disclosure may regularize the representation learning and seamlessly convert the features to segmentations, which can be used for privacy-preserving visual localization. Pose refinement, which involves aligning either feature maps or segmentations from a query image with those rendered from the GSFFs scene representation, is used to achieve visual localization.

Different types of VL can be distinguished by how they represent scenes and how they estimate the pose of a query image with respect to the scene representation. Examples include 3D Structure-from-Motion (SfM) point clouds, databases of images with known intrinsic and extrinsic parameters, the weights of neural networks, or dense renderable representations such as meshes, neural radiance fields, or 3D Gaussian Splatting.

VL may involve establishing 2D-3D correspondences via feature matching or scene coordinate regression, relative pose estimation from feature matches or regression, absolute pose regressed via neural networks, or feature-based pose refinement of an initial pose estimate. While local feature matching based approaches may provide accurate camera pose estimates, scale to large scenes, handle changing conditions and can be executed on mobile devices (e.g., cellular phones), they suffer from potential privacy-related issues as image details can be recovered from the feature descriptors.

Since VL systems and methods may be deployed through cloud-based solutions, preserving the privacy of user-uploaded images and scenes is a critical aspect. An interesting approach to both query and scene privacy is discussed herein involving pose refinement hat represents the scene as a sparse SfM point cloud. Most refinement-based methods project and/or render features associated with the scene geometry into the query image. An initial pose estimate, such as obtained via image retrieval, is then optimized by aligning the projected feature with features extracted from the query image. To increase privacy while decreasing memory requirements by avoiding storing high-dimensional features, the present disclosure may quantize the features into integer values which may be considered equivalent to assigning segmentation labels to pixels in the query image and the 3D scene points. The quantized representations may lead to better privacy-preservation: only coarse image information without any details can be recovered from both 2D segmentation images and 3D point clouds with associated labels. Final poses are refined by maximizing label consistency between the projected points and pixel labels.

The segmentations used are learned purely in 2D providing no guarantee that the predicted labels are consistent between viewpoints. In contrast, other systems may jointly train a dense scene representation (in the form of a neural radiance field (NeRF)) together with an implicit feature field, ensuring multi-view consistency and accurate feature based pose refinement results, but it is not privacy-preserving. In contrast, the present disclosure investigates learning a feature field that can be used for privacy-preserving visual localization jointly with a dense scene representation. More specifically, 3D Gaussian Splatting (3DGS) is used to its fast rendering time, making it particularly suited for dense pose refinement. 3DGS use allows ground representation learning in 3D. Additionally, the explicit and finite nature of 3DGS is better suited for privacy-preserving localization than NeRFs as the features associated with the Gaussians can be quantized.

Other 3DGS have pipelines that use matching-based solutions. In contrast, the present disclosure utilizes the ability to densely render from any viewpoint within the scene to perform feature-metric or segmentation based pose refinement. The present disclosure involves backpropagating through the rasterizer to the se(3) Lie algebra, which yields more accurate pose estimates. Instead of relying on pre-trained features, the present disclosure involves learning features in a self-supervised manner defining a Gaussian Spatting Feature Field (GSFFs), which associates 3D Gaussians with volumetric features extracted with a kernel-based encoding based on the covariance of the 3D Gaussians. These features are rendered and aligned to features provided by the 2D encoder (which is jointly trained with the GSFFs) through contrastive losses. Regularization may be applied by leveraging the geometry of the 3DGS model and by spatially clustering the GSFFs. The clusters enable converting features into segmentations that can be used to perform effective privacy-preserving pose refinement.

Generally speaking, the present disclosure introduces Gaussian Feature Fields, a novel representation for VL, jointly learned with the image feature encoder enabling pose refinement by aligning rendered and extracted features. The explicit nature of the 3D representation in GSFFs allows to spatially cluster the Gaussian cloud and segmenting the feature field based on cluster centers yielding a privacy-preserving 3D scene representation. The systems and methods are based on aligning discrete segmentation labels, thus leading to similar privacy preserving properties.

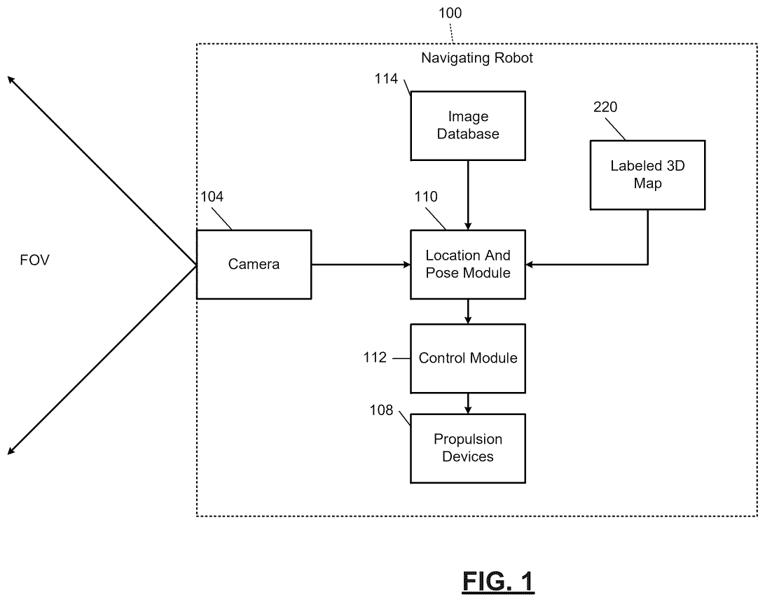

FIG. 1 is a functional block diagram of an example implementation of a navigating robot 100. The navigating robot 100 is a mobile vehicle. The navigating robot 100 includes a camera 104 that captures images within a predetermined field of view (FOV) in front of the navigating robot 100. The operating environment of the navigating robot 100 may be an indoor space or an outdoor space. In various implementations, the navigating robot 100 may include multiple cameras and/or one or more other types of sensing devices (e.g., LIDAR, radar, etc.).

The camera 104 may be, for example, a grayscale camera, a red, green, blue (RGB) camera, or another suitable type of camera. In various implementations, the camera 104 may also capture depth (D) information, such as in the example of a grayscale-D camera or a RGB-D camera. The camera 104 may be fixed to the navigating robot 100 such that the orientation and FOV of the camera 104 relative to the navigating robot 100 remains constant.

The navigating robot 100 includes one or more propulsion devices 108, such as one or more wheels, one or more treads/tracks, one or more moving legs, one or more propellers, and/or one or more other types of devices configured to propel the navigating robot 100 forward, backward, right, left, up, and/or down. One or a combination of two or more of the propulsion devices 108 may be used to propel the navigating robot 100 forward or backward, to turn the navigating robot 100 right, to turn the navigating robot 100 left, and/or to elevate the navigating robot 100 vertically upwardly or downwardly.

The navigating robot 100 includes a location and pose module 110 (or more simply a pose module) configured to determine a present location/position (e.g., three dimensional (3D) position) of the navigating robot 100 and a present pose (e.g., 3D orientation) of the navigating robot 100 based on input from the camera 104. A three 3D position of the navigating robot 100 and a 3D orientation of the navigating robot 100 may together be said to be a 6 dimension of freedom (6DoF) pose of the navigating robot 100. The 6 DoF pose may be a relative pose or an absolute pose of the navigating robot 100. A relative pose may refer to a pose of the navigating robot 100 relative to one or more objects in the environment around the navigating robot 100. An absolute pose may refer to a pose of the navigating robot 100 within a global coordinate system. The location and pose module 110 determines the pose as described further below.

The camera 104 may update at a predetermined frequency, such as 60 hertz (Hz), 120 Hz, or another suitable frequency. The location and pose module 110 may generate a location and/or the pose each time the input from the camera 104 is updated using a labeled three dimensional (3D) map 220.

A control module 112 is configured to control the propulsion devices 108 to navigate, such as from a starting location to a goal location, based on the location and the pose. For example, based on the location and the pose, the control module 112 may determine an action to be taken by the navigating robot 100. For example, the control module 112 may actuate the propulsion devices 108 to move the navigating robot 100 forward by a predetermined distance under some circumstances. The control module 112 may actuate the propulsion devices 108 to move the navigating robot 100 backward by a predetermined distance under some circumstances. The control module 112 may actuate the propulsion devices 108 to turn the navigating robot 100 to the right by the predetermined angle under some circumstances. The control module 112 may actuate the propulsion devices 108 to turn the navigating robot 100 to the left by the predetermined angle under some circumstances. The control module 112 may not actuate the propulsion devices 108 to not move the navigating robot 100 under some circumstances. The control module 112 may actuate the propulsion devices 108 to move the navigating robot 100 upward under some circumstances. The control module 112 may actuate the propulsion devices 108 to move the navigating robot 100 downward under some circumstances. The control module 112 may actuate the propulsion devices 108 to avoid the navigating robot 100 contacting any objects.

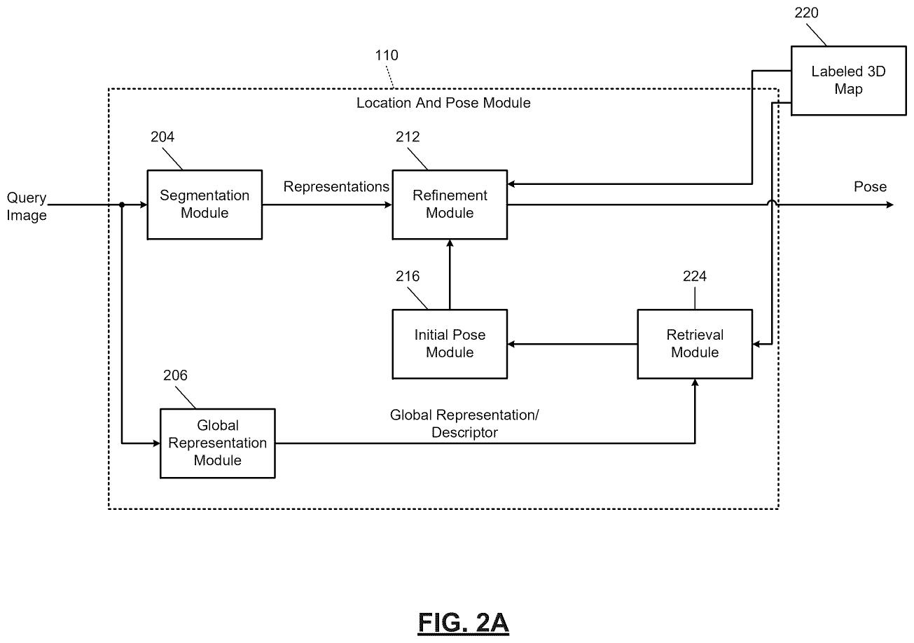

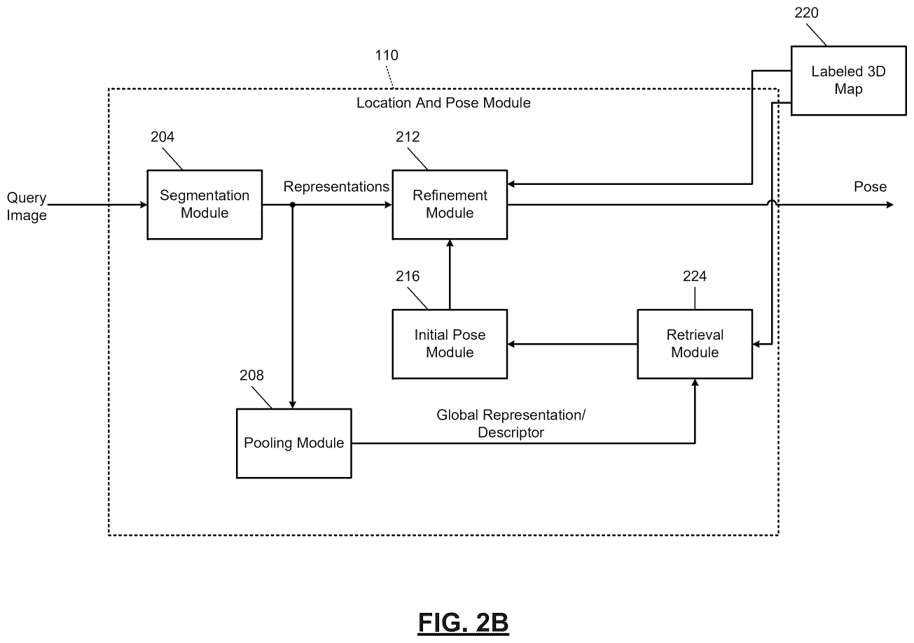

FIGS. 2A, 2B, and 3 are functional block diagrams of example pose determination systems. The example of FIG. 2A includes independent determination of a global representation based on a query image. The example of FIG. 2B includes joint determination of a global representation and a local representation. A goal is to jointly learn local and global image representations for visual localization. This involves a segmentation module 204 learning robust fine-grained segmentation in a weakly-supervised manner. For the weak supervision, an ensemble (dataset) of image pairs with a set of automatically extracted keypoint correspondences may be used.

The location and pose module 110 includes the segmentation module 204. The segmentation module 204 includes an encoder module and a decoder module as backbone such that the output of each layer is the input of the next layer. The resolutions of the output decoded feature maps Fₗ∈ [symbol] ^{D×Hl×Wl} may progressively increase.

Each feature map Fₗ may be further processed by a classification module (head) of the segmentation module 204 to generate segmentation heatmaps

$${P}_{l}^{k} ∈ {ℝ}^{{H}_{l} \times {W}_{l}}$$

—with per pixel class likelihoods corresponding to the k-th cluster. In other words, at each hierarchy level I, the segmentation module 204 generates K segmentation heatmaps for the K classes corresponding to the K clusters, respectively. The present disclosure however is applicable to other classes. Each segmentation heatmap k includes for each pixel the likelihood that it belongs to the class k. A tensor may be generated by the segmentation module 204 by concatenating the K segmentation heatmaps at level l and may be denoted by Pₗ∈R^{K×Hl×Wl} and may be an (e.g., abstract) representation of the query image.

As the decoder module outputs higher resolution feature (segmentation heat) maps, the encoded information becomes finer. Four or another suitable number of complementary distinct metric spaces and classification spaces may therefore be used (l∈1 . . . 4).

In the example of FIG. 2A, the location and pose module 110 includes a global representation module 206 that determines a global representation/descriptor based on the query image. In the example of FIG. 2B, a pooling module 208 pools the output representations of the segmentation module 204 to produce the global representation/descriptor.

A refinement module 212 may determine a refined pose (R, T) based on the segmentation heat maps, such as hierarchically from coarser to finer, and data (e.g., representations) in the map 220. This may leverage visual information captioned at different level of granularity. For pose approximation, only the finer segmentation may be used to compute a global representation. In the following, the level notation I will not be used for readability as the described functions are applied on each level without distinction.

The encoder module is pretrained and provides initial dense representations that are grouped into K clusters where K is controlling the granularity of information captured within in each cluster. This granularity is different than the spatial granularity level l, which corresponds to information captured at different layer resolution. To learn segmentation classes in a self-supervised manner, a Deep Discriminative Clustering (DDC) framework may be used as it may focus on learning the boundaries between clusters rather than explicitly modelling data distribution casting the clustering task as a classification problem. A training module (discussed further below) may use an auxiliary target to supervise the training by minimizing, for example, the Kullback-Leibler (KL) divergence between the predicted distributions P and target distributions Q.

To avoid degenerated solutions, a regularization term could be used by the training module to minimize KL(d^{q}∥d^{u}) between the empirical label distribution d^{q} which may be defined as the soft frequency of cluster assignments in the target distribution and the uniform distribution d^{u} to enforce a balanced cluster assignments. In the present disclosure, however, the training module instead relies on the data itself to directly estimate an empirical label distribution d^{p}. In addition, the training module may train the segmentation module 204 based on an entropy term H(Q) that encourages peaked target distributions. The clustering objective minimized by the training module may be described as follows:

$$ℒ\_DC = K L ( Q ‖ P ) + KL ( {d}^{⋀} q ‖ {d}^{⋀} p ) + H ( Q ) \qquad ( 1 )$$

where

$${d}_{k}^{q} = {\sum }_{i}^{H W B} {q}_{i k}$$

and B is the patch size. As this objective depends both on the target distributions Q and network parameters, it may be minimized by alternating the following two sub-steps (1. and 2. below) in every batch:
1. Update target distribution by the training module: With network parameters fixed, the following closed-form solution minimizes the cost function Eq. (1) in the batch of size B, such as using the equation:

$${q}_{{i}_{b} k} = \frac{{d}_{k}^{p} {p}_{{i}_{b} k}^{2} / {( {\sum }_{{b}^{′} = 1}^{B} {\sum }_{{i}_{{b}^{′}} = 1}^{HW} {p}_{{i}_{b}^{′} k}^{2} )}^{\frac{1}{2}}}{\frac{{\sum }_{k = 1}^{K} {d}_{k}^{p} {P}_{{i}_{b} k}^{2}}{{( {\sum }_{{b}^{′} = 1}^{B} {\sum }_{{i}_{{b}^{′}} = 1}^{HW} {p}_{{i}_{b}^{′} k}^{2} )}^{\frac{1}{2}}}} \qquad ( 2 )$$

2. The training module performs supervised learning/training of the segmentation module 204. With target distributions fixed, the training module may update one or more parameters of the segmentation module 204 based on minimizing the following per-pixel cross-entropy loss:

$${ℒ}_{CE} = - \frac{1}{HWB} {\sum }_{b = 1}^{B} {\sum }_{{i}_{b} = 1}^{H W} {\sum }_{k = 1}^{K} {q}_{{l}_{b} k} log ( σ ( {p}_{{i}_{b} k} ) ) \qquad ( 3 )$$

The segmentation module 204 may be self-supervised by auxiliary target distributions Q where qᵢₖ are computed from the initial class predictions pᵢₖ. However, these predictions may not be reliable at the beginning of the training process. During the first epoch, instead of using equation (2) to update Q, the training module may use initial prototypes (cluster centers) cₖ and compute soft assignments with respect to the associated cluster for each pixel xᵢ with a distribution, such as the Student's t-distribution, such as described by the equation:

$${q}_{i k} = \frac{{( 1 + \frac{{‖ {F}_{i} - {c}_{k} ‖}_{2}^{2}}{α} )}^{- \frac{α + 1}{2}}}{{\sum }_{j = 1}^{K} {( 1 + \frac{{‖ {F}_{i} - {c}_{j} ‖}_{2}^{2}}{α} )}^{- \frac{α + 1}{2}}} \qquad ( 4 )$$

using the corresponding feature vectors Fᵢ and α=1. Using equation (4) in the first epoch may not only act as an initialization but also distils underlying prior knowledge helping the learning process to be more efficient.

Aiming to define dense representation robust to photometric changes while being equivariant to viewpoint changes and to avoid overfitting, the training module may train the segmentation module 204 based on (e.g., minimizing) the following three consistency regularization losses [symbol] _{CC}, [symbol] _{PC}, and [symbol] _{PF}.

Let Iₐ, I_{b} be an image pair with the corresponding I2-normalized feature maps F^{a}=f_{θ}(I^{a}) and F^{b}=f_{θ}(I^{b}) respectively. The set of automatically obtained two dimensional 2D keypoint correspondences may be defined by

$${\{ {x}_{ul}^{a} , {x}_{v i}^{b} \}}_{l = 1}^{L}$$

where

$${x}_{u l}^{a} and {x}_{v i}^{b}$$

are keypoint locations in the feature map Fa and respectively Fb.

First, a correspondence consistency loss will be described. This loss may enforce consistency between pairs of segmentations

$${ℒ}_{C C} = - \frac{1}{2 L} {\sum }_{l = 1}^{L} {1}_{{S}_{{v}_{l}}^{b}}^{T} log ( α ( {p}_{{u}_{1}}^{a} ) ) + {1}_{{s}_{{u}_{l}}^{a}}^{T} log ( α ( {p}_{{v}_{1}}^{b} ) )$$

where

$${p}_{u l}^{a} = {h}_{μ} ( {F}_{u l}^{a} ) and {p}_{v l}^{b} = {h}_{μ} ( {F}_{v l}^{b} ) ,$$

[symbol]

ₖ is the one-hot vector with all zero values except at positions k,

$${s}_{u l}^{a} , and {s}_{v l}^{b}$$

are assigned cluster labels to the keypooints

$${x}_{u l}^{a} and {x}_{v l}^{b}$$

based on their distance prototypes

$${\{ {c}_{k} \}}_{k = 1}^{K}$$

obtained as

$${s}_{u l}^{a} = arg {max}_{k} {c}_{k}^{T} {F}_{u l}^{a} and {s}_{v l}^{b} = arg {max}_{k} {c}_{k}^{T} {F}_{v l}^{b} .$$

Using the assigned prototypes instead of the target distribution may allow for the distillation of prior knowledge through the training process through the prototypes. The pose module may determine the initial prototypes based on the cluster centers of the training images input.

Second, a prototypical cross contrastive loss will be described. To constrain the feature space to ensure separability between the implicitly defined classes and to improve intra-class compactness, the following prototypical cross contrastive loss may be used (e.g., minimized) to train the segmentation module 204 by the training module and described by the equation

$${ℒ}_{P C} = - \frac{1}{2 L} {\sum }_{l = 1}^{L} log ( \frac{1}{Z} exp ( \frac{{c}_{{S}_{{v}_{l}}^{b}}^{T} {F}_{{u}_{l}}^{a}}{{∅}_{{S}_{{v}_{l}}^{b}}} + \frac{{c}_{{S}_{{u}_{l}}^{a}}^{T} {F}_{{v}_{l}}^{b}}{{∅}_{{S}_{{u}_{l}}^{a}}} ) )$$

with

$$Z = ( {Σ}_{k} exp ( \frac{{c}_{k}^{T} {F}_{{u}_{l}}^{a}}{{∅}_{k}} ) ) ( {Σ}_{k} exp ( \frac{{c}_{k}^{T} {F}_{{v}_{l}}^{b}}{{∅}_{k}} ) ) ,$$

φₖ being the concentration of the prototype cₖ which may be defined as the average feature distance to the prototype within the cluster k and it may act as a scaling factor preventing cluster collapse. This loss incorporates in the feature space a structure conveyed by the prototypes.

Third, a feature consistency loss will be described, which may be used (e.g., minimized) by the training module. The feature consistency loss may be used to exploit the relationships between keypoints in the feature space (matching keypoints have similar representations) and may be described by the equation below to enforce feature consistency

$${ℒ}_{F C} = - \frac{1}{L} {Σ}_{l = 1}^{L} \frac{log exp ( \frac{{F}_{{u}_{i}}^{{a}^{T}} {F}_{{v}_{l}}^{b}}{τ} )}{{Σ}_{j = 1}^{L} exp ( \frac{{F}_{{u}_{l}}^{{a}^{T}} {F}_{j}^{b}}{τ} )} \qquad ( 5 )$$

The anchor/positive pairs may be provided by the pixel to pixel correspondences, while negative pairs may be obtained by sampling amongst the other keypoints in the set

$$\{ {x}_{vj}^{b} , j \neq l \} .$$

This loss may force the features of corresponding keypoints to be similar, hence facilitating the subsequent clustering.

To fully leverage these segmentation based representations, a pooling module 208 may determine a global image representation by applying a pooling operator on the segmentation heatmaps instead of the feature maps. The pooling operator may be, for example, the Generalized Pooling Operator (GPO) which may generalize over different pooling strategies to learn a most appropriate pooling strategy to describe the global content.

Given a heatmap's channel P^{k}∈ [symbol] ^{H×W}, the global representation may be defined as a weighted sum over sorted features:

$${v}^{k} = {Σ}_{0 = 1}^{H W} {θ}_{O} {ψ}_{O}^{d} where {Σ}_{0 = 1}^{H W} {θ}_{O} = 1 \qquad ( 6 )$$

where v^{k} is the k-th element of the output feature vector,

$${ψ}_{o}^{k}$$

is the o-th element from the ordered descending lists of the values in the in the heatmap's channel, P^{k} and the weights θₒ are shared between the channels. The higher (or highest) resolution segmentation heatmap from the last level of the decoder module may be used as the input to the pooling module 208 to determine the global descriptor.

To increase the representational power, the segmentation module 204 may divide the query image into M overlapping sliding sub-windows and apply pooling within each sub-window. The corresponding features may be concatenated by the segmentation module yielding a global representation of dimension MK. In various implementations, the pooling module 206 may apply principle component analysis (PCA) and/or whitening, such as to reduce the dimension to 4096.

A goal of the training by the training module may be to minimize the multi-similarity loss which aims at exploiting self-similarity, negative, and positive relative similarities between these segmentation-based global representations. Given an anchor image

$${I}_{j}^{a}$$

the corresponding positive and respectively negative image sets can be denoted by

$${𝒩}_{n}^{+} = \{ {I}_{j}^{+} \} and {𝒩}_{n}^{-} = \{ {I}_{j}^{-} \}$$

and the corresponding similarities determined between the pooled global representations by

$${s}_{j n}^{+} and {s}_{j n}^{-} .$$

The training module may determine the multi-similarity loss using the equation:

$${ℒ}_{M S} = - \frac{1}{N} {\sum }_{n = 1}^{N} {\sum }_{ρϵ \{ + , - \}} \frac{1}{{α}^{ρ}} log ( 1 + {\sum }_{{I}_{j}^{ρ} ϵ {N}_{n}^{ρ}} {e}^{{ρα}^{ρ} ( λ - {S}_{j n}^{ρ} )} )$$

where α+, α− and λ are hyper-parameters. Image pairs included in the dataset may be used as an anchor/positive pair. The rest of positive/negative samples may be mined from

$${\{ {I}_{{n}^{′}}^{a} , {I}_{{n}^{′}}^{b} \}}_{{n}^{′} \neq n}$$

through a mining scheme (e.g., hard or semi-hard) based on features distances and image positions.

The location and pose module 110 determines the pose using a three dimensional (3D) representation of the environment, the 3D map 220, that includes for a set of reference images their corresponding camera pose and global descriptors (but not the images themselves) as well as a labelled 3D map that may be a sparse 3D model. Each 3D point is associated to one of a predefined set of class labels instead of a visual descriptor.

First, given a query image, the dense representations (segmentation heatmaps) and the global representation are determined as discussed above. A retrieval module 224 retrieves the top-k most relevant images from the map 220 based on global descriptor similarity (e.g., cosine similarity). top-k is a predetermined value and is an integer greater than or equal to 1. The initial pose module 216 determines an initial pose based on the retrieved images.

Second, the refinement module 212 refines the initial pose that was derived from the retrieved images. The refinement module 212 determines the refined pose based on the initial pose. The pose refinement process performed by the refinement module 212 may be described follows.

Let (R₀, T₀) be the initial pose obtained using the poses of the top-k retrieved similar images, and let X={(Xm, ym)} be the set of labeled 3D points visible in the top-k images, where Xm represents its 3D coordinates and ym the associated class label. To refine the initial pose, the refinement module 212 may use geometric optimization. To find the (refined) camera pose of the query image (R, T), the refinement module 212 does not use the reference images nor complex features. Instead, the refinement module 212 generate the refined pose by minimizing the label inconsistency between the reprojected 3D labels (yₘ) and the value (pₘ) in the predicted segmentation map of the query image. This may be defined by the equation

$$E ( R , T ) = {\sum }_{X} {w}_{m} ρ ( \vert {p}_{m} - {1}_{{y}_{m}} \vert ) \qquad ( 7 )$$

where 1k is the one-hot vector with all zero values except at position yₘ, pₘ is the segmentation class probability vector for xₘ=K(RXₘ+T), K being a query camera matrix, (R, T) the initial pose, and wₘ are learned weights, such as for outdoor environments or weights derived from edge detectors for indoor environments. In various implementations, the parenthetical in equation (7) may be replaced by a binary indicator of whether the same label is present or not.

(R, T) by (R₀, T₀) may be initialized and be iteratively refined by the refinement module 212 by minimizing equation (7), such as with the Levenberg-Marquart algorithm, where ρ being a Cauchy robust cost function

$$ρ ( x ) = \frac{{ψ}^{2}}{2} log ( 1 + \frac{{χ}^{2}}{ψ} )$$

where ψ is a predetermined value, such as 0.1. In other words, the refinement module 212 may refine, execute equation (7), and stop once an increase in the result of equation (7) is obtained. The refinement module 212 may use the refined pose from the last instance before equation (7) increased. For each query image, the location and pose module 110 may perform this refinement with regard to the map 220 using coarser to finer segmentation-based representations.

As the query, the location and pose module 110 may either use the full segmentation heatmap, part of it or a single label representation. This is different than using a (e.g., dense) feature map. Using a one-hot query may provide a high level of privacy while increasing the amount of encoded information facilitates localization at the cost of lowering privacy.

For visual localization and pose determination, a computing device may transmit a query to a server. The server (e.g., including the location and pose module 110) performs visual localization using a stored 3D database (e.g., map 220) and returns the 6 DoF pose to the computing device. Privacy may be described in terms of the inability of an entity to recover details of the scene from either the query or the database. Determining the refined pose as described herein provides more privacy than other ways of determining pose, such as based on features. Memory use associated with the map 220 used herein may also be less than the memory used to determine pose based on features.

FIG. 3 is a functional block diagram illustrating the example of FIGS. 2A and 2B.

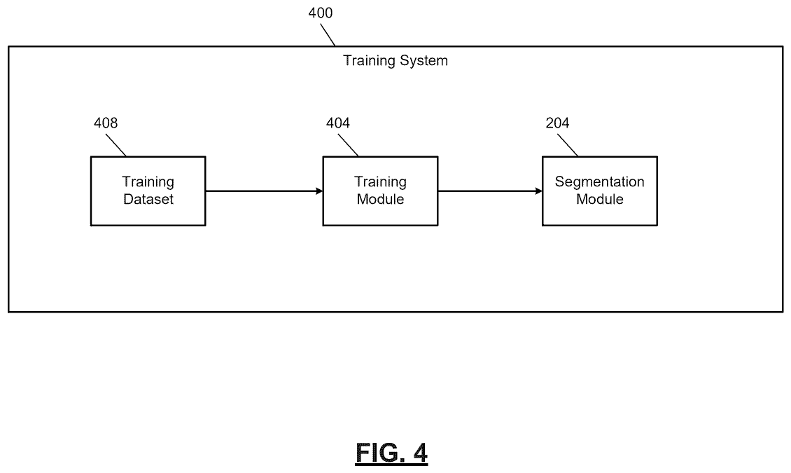

FIG. 4 is an example training system 400. A training module 404 trains the segmentation module 204 using a training dataset 408 as described herein. The segmentation module 204 may be trained offline, while the location and pose module 110 may perform an optimization process online during localization.

Regarding the training dataset 408 used by the training module 404 to train the location and pose module 110, the training dataset 408 may include a set of anchor/positive/negative images and pixel level information in the form of dense correspondences. For example, the training module 404 may, for example, determine repeatable and reliable detector and descriptor (R2D2) local descriptors in the images. The training module may merge image sets from different weather conditions to build a model (e.g., a structure from motion (SfM) model) by triangulating 2D matches using the camera poses then build a second model (e.g., a dense model) using a multi-view stereo pipeline. The training module 404 may split the resulting model (e.g., dense cloud points) into sub-point clouds, each of them being associated to a specific weather condition (based on the condition labels of the training images provided by the dataset). A 3D point may be associated with a sub-point cloud if it is observed by at least three images captured under that given weather condition. The SFM may be built with R2D2 features are used to generate the map 220 and the training data, but for the localization performed by the location and pose module 110 online, only the labels may be used and keypoint descriptors may be removed. During the training, the weight parameters wₘ may be trained by the training module 404.

Given a pair of sub-point clouds, 3D-3D correspondences may be established by the training module 404 by finding mutual nearest neighbors. Reprojecting these points into the images by the training module 404 yields a list of 2D-2D correspondences for all image pairs that are part of the sub-point clouds. The training module 404 may reject all 3D-3D correspondences whose reprojection error is greater than a threshold value, such as 5 pixels. The training module 404 may eliminate image pairs with less than a predetermined number of correspondences, such as 500 correspondences.

As another option, the training module 404 may build a model (e.g., a sparse SfM model) from scale invariant feature transform (SIFT) keypoints and not split the dense point cloud depending on capture condition as the scene may not evenly be covered by each capture condition. Thus for an image, the candidate image pair may be searched by the training module 404 among the whole training dataset 408. The global representations may be spatially pooled by the training module 404 from the dense segmentation which may be equivariant with respect to viewpoint change. As the global representations show some level of invariance to viewpoint change, the training image pairs may have limited viewpoint change and sufficient visual overlap. The bounding box containing all 2D points within the first image may be reprojected (e.g., rendered) by the training module 404 in the second image and vice versa. Overlap ratios between the reprojected bounding boxes and images may be computed and used to select pairs with a sufficient correspondence coverage eliminating pairs below a predetermined value, such as 0.75 or another suitable value. The training module 404 may discard pairs with relative rotation differences greater than a predetermined value, such as 25 degrees or another suitable value.

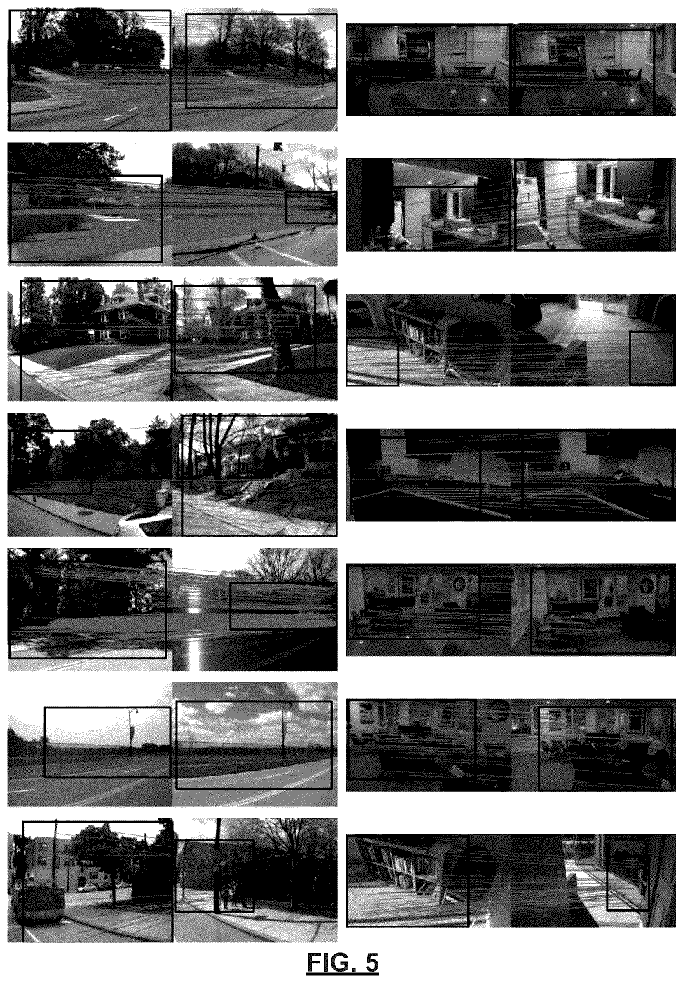

FIG. 5 includes example pairs of images with 2D-2D correspondences between the images of each pair from the training dataset 408.

An initial clustering may be performed by the segmentation module 204 to generate dense representations including initial prototype distributions (derived based on cluster centers), using the weights of a segmentation model that can be a pretrained segmentation model. The derived prototypes play multiple roles. In the first epoch, the prototypes are used to determine the pseudo targets to train the classifiers, which may help to ensure a good initialization of the discriminative clustering phase. The prototypes also help to regularize the training process by incorporating some semantic structures in the feature space. To better ensure a good initialization, an available pre-trained segmentation module 204 may be used to extract and cluster per pixel features considering a random subset of the training set (reference images). Using a pre-trained segmentation module may provide some meaningful features for the clustering.

For example only, the segmentation module 204 may include the DPT-hybrid model described in Rene Ranftl, et al., Vision Transformers for Dense Prediction, in ICCV, 2021, which is incorporated herein in its entirety. In the initialization step, reference images are processed and dense features from the encoder module are sampled and their associated predictions are collected. The dense features may be grouped according to their predictions (e.g., removing classes with low population). Within each remaining class, sub-clustering using K-means, meanshift, or another suitable type of clustering may be applied. The parameter k of K-means clustering or the Meanshift clustering's bandwidth such that the total number of prototypes and/or segmentation classes equals the target granularity K of the segmentation. This initial clustering step may be applied independently on each level I of the hierarchical decoder module yielding four sets of initial prototypes, which may be refined during training to represent coarser to finer information.

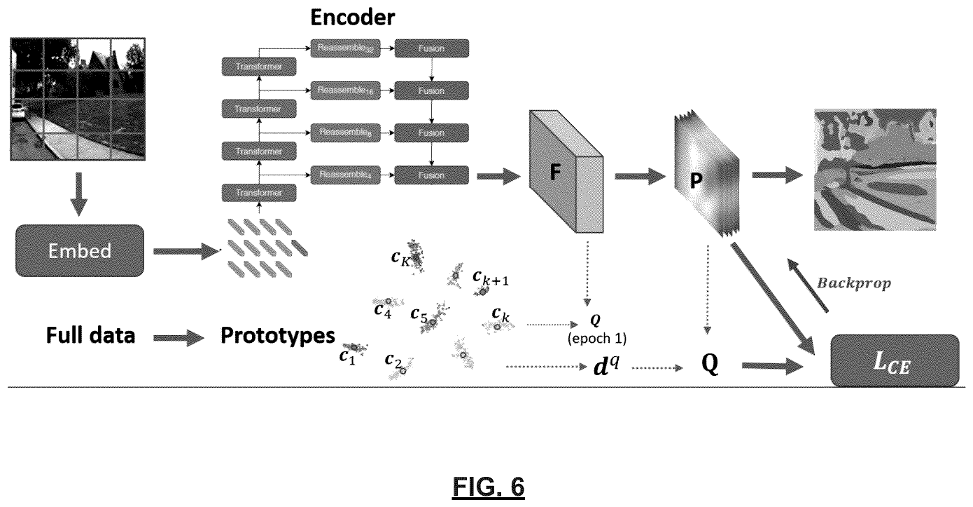

FIG. 6 includes an example illustration of portions of the segmentation module 204 of FIGS. 2A and 2B and illustrates the discriminative clustering process, which may be casted as a classification task. Pseudo targets Q are determined and used in determining per pixel cross-entropy loss [symbol] _{CE}. As discussed above, the segmentation module includes a hierarchical encoder/decoder module architecture, such as with vision transformer modules having the transformer architecture and convolutions. Transformer architecture as used herein is described in Ashish Vaswani, Noam Shazeer, Niki Parmar, Jakob Uszkoreit, Llion Jones, Aidan N Gomez, Łukasz Kaiser, and Illia Polosukhin, “Attention is all you need”, In I. Guyon, U. V. Luxburg, S. Bengio, H. Wallach, R. Fergus, S. Vishwanathan, and R. Garnett, editors, Advances in Neural Information Processing Systems 30, pages 5998-6008, Curran Associates, Inc., 2017, which is incorporated herein in its entirety. Additional information regarding the transformer architecture can be found in U.S. Pat. No. 10,452,978, which is incorporated herein in its entirety. The transformer architecture is one way to implement a self-attention mechanism, but the present disclosure is also applicable to the use of other types of attention mechanisms.

After the initial clustering, the classification head of each decoder level of the pre-trained model may be replaced, such as with a randomly initialized multi layer perceptron (MLP) followed by batch normalization. The number of target segmentation classes is set to K. K may be, for example, 100 or another suitable value. Coarser or finer segmentations may be achieved by varying K. The dimension of the feature map F is set to D, such as 256 or another suitable value.

The training module 404 may train the location and pose module 110 using Adam optimizer with an initial learning rate, such as 2e-3 and a predetermined weight decay, such as 1e-4.

In the example of FIG. 6, the prototypes/feature similarities may be used as targets during the first epoch. In the following epochs, the target distributions may act as pseudo-labels to guide the segmentation.

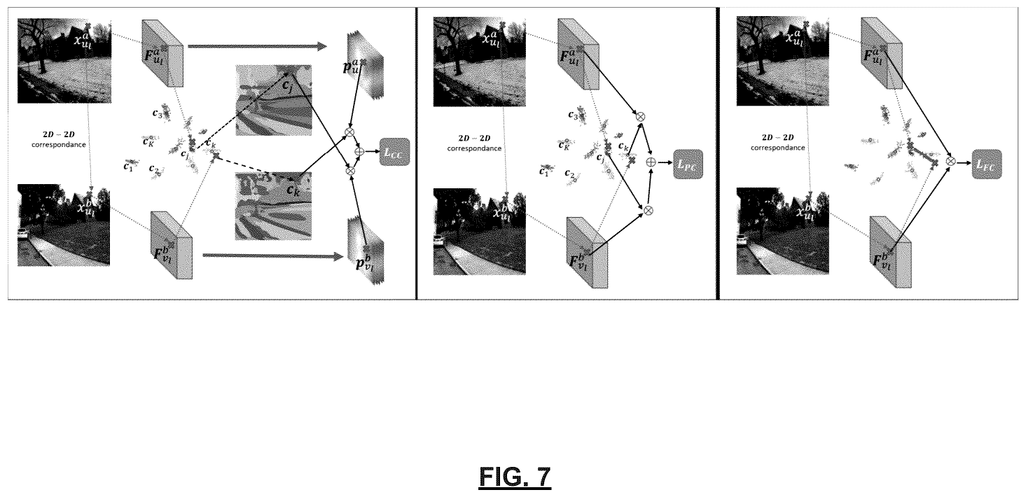

FIG. 7 illustrates the behavior of consistency losses [symbol] _{CC}, and [symbol] _{FC} and contrastive loss [symbol] _{PC} discussed above. Given a pixel to pixel correspondence and a set of prototypes, consistency may be enforced between the representations while class information may be infused from the prototypes. The left most diagram of FIG. 7 illustrates the consistency loss [symbol] _{FC} between the values in the segmentation heatmap of corresponding keypoints. The middle diagram of FIG. 7 illustrates the prototypical cross contrastive loss [symbol] _{PC}. The right most diagram of FIG. 7 illustrates the feature consistency loss [symbol] _{FC}.

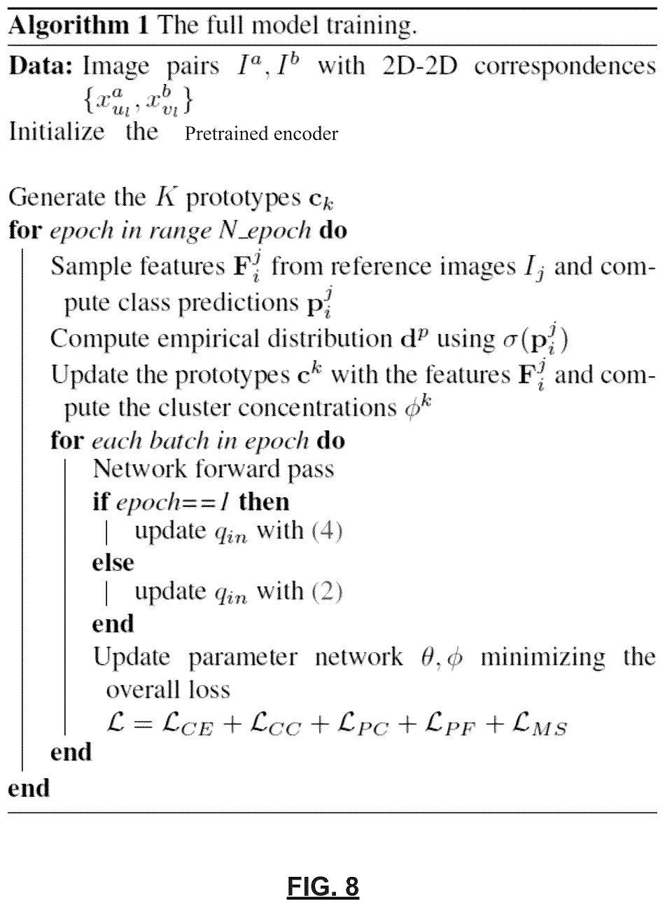

FIG. 8 includes an algorithm for training the segmentation module 204 used by the training module 404. First, the training module 404 initializes the pre-trained encoder module of segmentation module 204. Then the segmentation module 204 generates the initial K prototypes and learns the model to generate the dense and global representations based on the image pairs of the training dataset 408.

For each epoch of a predetermined number of epochs (a range), the segmentation module 204 samples features from the reference images and determines class predictions as discussed above. The segmentation module 204 determines an empirical distribution as discussed above and updates the prototypes based on the features and determines the cluster concentrations.

For each batch in an epoch, the training module 404 determines q using equation (4) above during the first epoch. During each epoch after the first epoch, the training module 404 determines q using equation (2) above. For each batch, the training module 404 determines the losses discussed above, determines a total (overall) loss as shown, and updates one or more parameters of the segmentation module 110 based on minimizing the total loss.

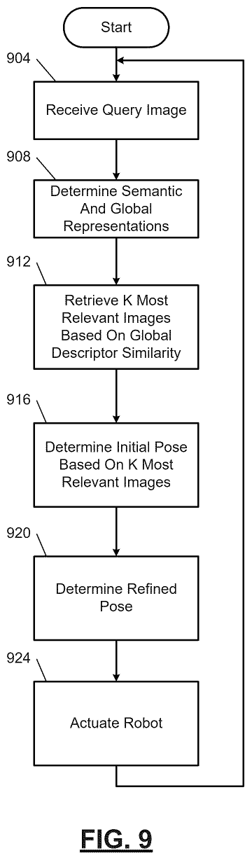

FIG. 9 is a flowchart depicting an example method of determining a refined pose and controlling movement of a robot. Control begins with 904 where the location and pose module 110 receives an image, such as an image from the camera 104. The location and pose module 110 is configured and trained to determine a refined pose of the camera that captured the image.

At 908, the segmentation module 204 determines the dense segmentation-based representations and the global descriptor for the query image as discussed above. At 912, the retrieval module 224 retrieves or identifies the k most relevant images based on similarities (e.g., cosine) between the global descriptor of the query image and the global descriptors of the images in the map 220.

At 916, initial pose module 216 determines the initial 6 DoF pose based on the k most relevant images retrieved from the map 220. At 920, the refinement module 212 determines the refined 6 DoF pose by refining the initial 6 DoF pose as discussed above. At 924, the control module 112 may control actuation of one or more of the propulsion devices or other actuators of the robot based on the refined 6 DoF pose.

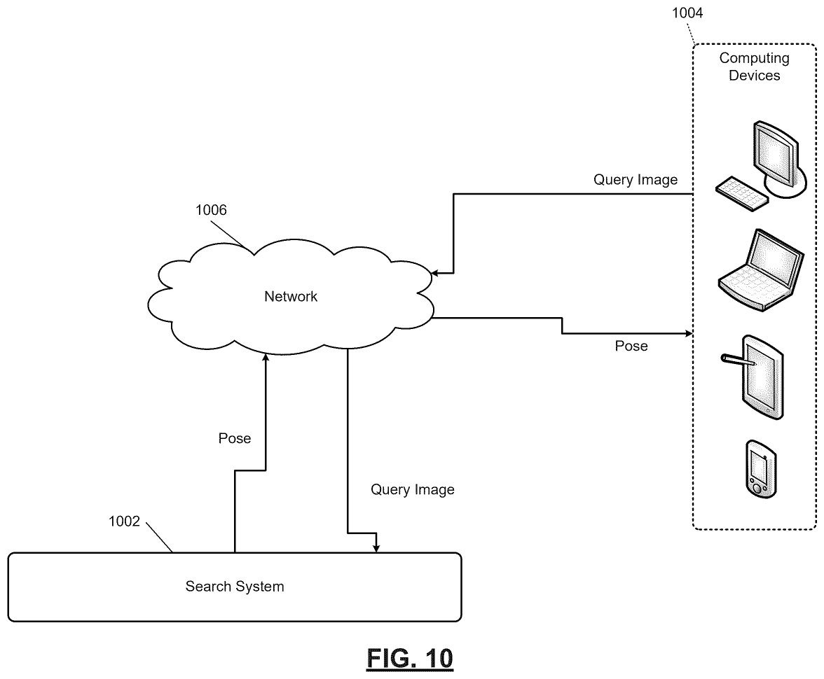

FIG. 10 includes a functional block diagram including a visual localization system. A search system 1002 (e.g., including the location and pose module 110) is configured to respond to queries. The search system 1002 is configured to receive queries from one or more computing device(s) 1004 via a network 1006. The queries may be, for example, images, such as images captured using a camera of the computing device and/or images captured in one or more other manners.

The search system 1002 determines a pose of the camera that captured the image as discussed above. The search system 1002 may also perform searches for images based on the queries, respectively, to identify one or more search results. The search system 1002 transmits the 6 DoF pose and/or results back to the computing devices 1004 that transmitted the queries, respectively. For example, the search system 1002 may receive a query including an image from a computing device. The search system 1002 may provide a matching image having a closest 6 DoF to the query image and other information about one or more objects in the images back to the computing device.

The computing devices 1004 output the results to users. For example, the computing devices 1004 may display the results to users on one or more displays of the computing devices and/or one or more displays connected to the computing devices. Additionally or alternatively, the computing devices 1004 may audibly output the results via one or more speakers. The computing devices 1004 may also output other information to the users. For example, the computing devices 1004 may output additional information related to the results, advertisements related to the results, and/or other information. The search system 1002 and the computing devices 1004 communicate via a network 1006.

A plurality of different types of computing devices 1004 are illustrated in FIG. 10. The computing devices 1004 include any type of computing devices that is configured to generate and transmit queries to the search system 1002 via the network 1006. Examples of the computing devices 1004 include, but are not limited to, robots (e.g., navigating robot 100 in FIG. 1), smart (cellular) phones, computers (including tablet computers, laptop computers, and desktop computers), virtual assistant and autonomous vehicles (including autonomous drones), as illustrated in FIG. 10. The computing devices 1004 may also include other computing devices having other form factors, such as computing devices included in other networked appliances (e.g., networked vacuum cleaners, networked lawn mowers, etc.).

The computing devices 1004 may use a variety of different operating systems. In an example where a computing device 1004 is a mobile device, the computing device 1004 may run an operating system including, but not limited to, Android, IOS developed by Apple Inc., or Windows Phone developed by Microsoft Corporation. In an example where a computing device 1004 is a laptop or desktop device, the computing device 1004 may run an operating system including, but not limited to, Microsoft Windows, Mac OS, or Linux. The computing devices 1004 may also access the search system 1002 while running operating systems other than those operating systems described above, whether presently available or developed in the future.

In some examples, a computing device 1004 may communicate with the search system 1002 using an application installed on the computing device 1004. In general, a computing device 1004 may communicate with the search system 1002 using any application that can transmit queries to the search system 1002 to be responded to (with results) by the search system 1002. In some examples, a computing device 1004 may run an application that is dedicated to interfacing with the search system 1002, such as an application dedicated to performing searching and providing search results. In some examples, a computing device 1004 may communicate with the search system 1002 using a more general application, such as a web-browser application. The application executed by a computing device 1004 to communicate with the search system 1002 may display a search field on a graphical user interface (GUI) in which the user may input queries.

Additional information may be provided with a query, such as text. A text query entered into a GUI on a computing device 1004 may include words, numbers, letters, punctuation marks, and/or symbols. In general, a query may be a request for information identification and retrieval from the search system 1002. For example, a query including text may be directed to providing information regarding a subject (e.g., a business, point of interest, product, etc.) of the text of the query.

A computing device 1004 may receive results from the search system 1002 that is responsive to the search query transmitted to the search system 1002. In various implementations, the computing device 1004 may receive and the search system 1002 may transmit multiple results that are responsive to the search query or multiple items (e.g., entities) identified in a query. In the example of the search system 1002 providing multiple results, the search system 1002 may determine a confidence value for each of the results and provide the confidence values along with the results to the computing device 1004. The computing device 1004 may display more than one of the multiple results (e.g., all results having a confidence value that is greater than a predetermined value), only the result with the highest confidence value, the results having the N highest confidence values (where N is an integer greater than one), etc.

The computing device 1004 may be running an application including a GUI that displays the result(s) received from the search system 1002. The respective confidence value(s) may also be displayed, or the results may be displayed in order (e.g., descending) based on the confidence values. For example, the application used to transmit the query to the search system 1002 may also present (e.g., display or speak) the received search results(s) to the user via the computing device 1004. As described above, the application that presents the received result(s) to the user may be dedicated to interfacing with the search system 1002 in some examples. In other examples, the application may be a more general application, such as a web-browser application.

The GUI of the application running on the computing device 1004 may display the search result(s) to the user in a variety of different ways, depending on what information is transmitted to the computing device 1004. In examples where the results include a list of results and associated confidence values, the search system 1002 may transmit the list of results and respective confidence values to the computing device 1004. In this example, the GUI may display the result(s) and the confidence value(s) to the user as a list of possible results.

In some examples, the search system 1002, or another computing system, may transmit additional information to the computing device 1004 such as, but not limited to, applications and/or other information associated with the results, the query, points of interest associated with the results, etc. This additional information may be stored in a data store and transmitted by the search system 1002 to the computing device 1004 in some examples. In examples where the computing device 1004 receives the additional information, the GUI may display the additional information along with the result(s). In some examples, the GUI may display the results as a list ordered from the top of the screen to the bottom of the screen by descending confidence value. In some examples, the results may be displayed under the search field in which the user entered the query.

In some examples, the computing devices 1004 may communicate with the search system 1002 via another computing system. The other computing system may include a computing system of a third party using the search functionality of the search system 1002. The other computing system may belong to a company or organization other than that which operates the search system 1002. Example parties which may leverage the functionality of the search system 1002 may include, but are not limited to, internet search providers and wireless communications service providers. The computing devices 1004 may send queries to the search system 1002 via the other computing system. The computing devices 1004 may also receive results from the search system 1002 via the other computing system. The other computing system may provide a user interface to the computing devices 1004 in some examples and/or modify the user experience provided on the computing devices 1004.

The computing devices 1004 and the search system 1002 may be in communication with one another via the network 1006. The network 1006 may include various types of networks, such as a wide area network (WAN) and/or the Internet. Although the network 1006 may represent a long range network (e.g., Internet or WAN), in some implementations, the network 1006 may include a shorter range network, such as a local area network (LAN). In one embodiment, the network 1006 uses standard communications technologies and/or protocols. Thus, the network 1006 can include links using technologies such as Ethernet, Wireless Fidelity (WiFi) (e.g., 802.11), worldwide interoperability for microwave access (WiMAX), 3G, 4G, 5G, Long Term Evolution (LTE), digital subscriber line (DSL), asynchronous transfer mode (ATM), InfiniBand, PCI Express Advanced Switching, etc. Similarly, the networking protocols used on the network 1006 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 1006 can be represented using technologies and/or formats including the hypertext markup language (HTML), the extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc. In other examples, the network 1006 can use custom and/or dedicated data communications technologies instead of, or in addition to, the ones described above.

As one example, a computing device may transmit an image to the search system 1002 including an object, such as a landmark, etc. The search system 1002 may determine one or more images having a 6 DoF pose closest to the 6 DoF pose of the query image and links (e.g., hyperlinks) to websites including information on the object in the query image. The search system 1002 may transmit the images and the links back to the computing device for consumption.

3D Gaussian Splatting represents a scene as a set of Gaussian primitives and render images by rasterizing Gaussians using depth ordering and alpha blending, thus allowing efficient training and high resolution real-time rendering. With these properties, 3D Gaussians can be applied to numerous tasks including SLAM (simultaneous localization and mapping), dynamic scene modeling, scene segmentation, surface reconstruction, and other tasks. Anti-aliasing, sparse view setup, removing reliance on estimated poses, and regularization may be applied as extensions.

In this application, a Gaussian Opacity Fields model provides a 3D representation, which integrates an anti-aliasing module and offers highly accurate geometry through regularization. An example of the Gaussian Opacity Fields model is described In Zehao Yu, et al., Efficient Adaptive Surface Reconstruction in Unbounded Scenes, IEEE Transactions on Graphics, 43(6):1-15, 2024, which is incorporated herein in its entirety. An example of the anti-aliasing module is described In Zehao Yu, et al., Mip-splatting: Alias-free 3D Gaussian Splatting, in Proceedings of IEEE/CVF Conference on Computer Vision and Pattern recognition, pp. 19447-19456, 2024, which is incorporated herein in its entirety.

The GSFFs-PR pose refinement pipeline described herein associates a deep feature or a segmentation label to each 3D Gaussian primitive and performs pose refinement by 1) rasterizing these quantities and 2) explicitly backpropagating the feature-metric or segmentation errors through the rasterizer with regard to the camera pose.

Gaussian Splatting Feature Fields (GSFFs) will be introduced first. The Gaussian Splatting Feature Field (GSFFs) associate a scale aware feature to each 3D Gaussian. Joint optimization will be used with a 2D feature extractor by aligning rendered and 2D extracted features in a self-supervised manner. To further improve the features' discriminativeness and their 3D awareness, some prototypes may be extracted by clustering the 3D Gaussian cloud and they may be used to encourage that both features in a pixel aligned pairs of 2D/3D features are close to the same assigned prototype through an auxiliary contrastive loss. These prototypes not only help distill spatial information in the feature space, but also allow for a smooth transition from feature maps to segmentation maps enabling privacy preserving localization. The GSFFs-PR Feature visual localization pipeline is based on pose refinement through feature alignment. Its extension, the privacy-preserving GSFFs-PR Privacy visual localization pipeline is based on segmentations.

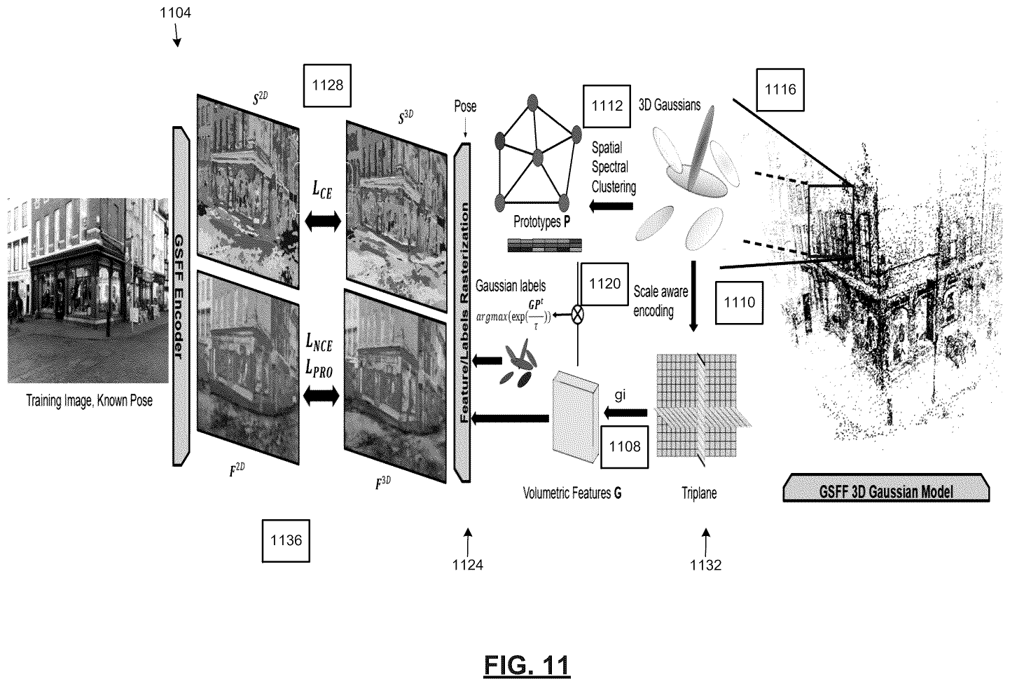

FIG. 11 includes a functional block diagram of an example of the GSFF-PR system. The training module 404 may perform the training described herein. An encoder module 1104 extracts a feature map F^{2D} and segmentation map S^{2D} from a training image with a known pose (left). For each 3D Gaussian Gᵢ (right), a scale aware feature gᵢ is extracted from a triplane representation by an extraction module 1108. Spectral clustering is applied by a clustering module 1112 on the Delaunay graph derived from a Gaussian cloud for the scene by a graphing module 1116, yielding a set of prototypes P. Each prototype is associated with a target segmentation class and/or a classification. A predetermined number of prototypes P may be included, such as 34 or another suitable number. A label (Gaussian label) is associated with each 3D Gaussian by assigning the volumetric features to the prototypes by a labeling module 1120. The features and labels are then rendered by a rasterization module 1124 to obtain the feature map F^{3D} and the segmentation map S^{3D} which are respectively aligned with their encoder counterparts F^{2D} and S^{2D} by an alignment module 1128. The segmentation maps S^{3D} and S^{2D} are aligned via losses L_{NCE}, L_{PRO}, the feature maps F^{3D} and F^{2D} are aligned via loss L_{CE}. The training module 404 trains the encoder module 1104 based on minimizing the losses.

The Gaussian Opacity Fields model may be used to generate the Gaussian Field representation, where a scene is composed of a set of 3D Gaussian primitives parametrized by their center, scaling, and rotation matrices, opacity and spherical harmonics coefficients. Given a ray r emanating from a camera pose P the Gaussian Opacity Fields model finds the intersection between the ray and 3D Gaussians and computes the contribution Cᵢ(r, P) of each Gaussian Gᵢ traversed by the ray. Each Gaussian Gi may include, for example, a center, a color, a covariance, an opacity, and a segmentation label. The Gaussians are then ordered based on depth and the pixel's color rendered by alpha blending, such as using the equation

$$c ( r , p ) = {\sum }_{i = 1}^{N} {c}_{i} {α}_{i} {C}_{i} ( r , P ) {\prod }_{j = 1}^{i - 2} ( 1 - {α}_{j} {C}_{j} ( r , P ) ) \qquad ( A )$$

where cᵢ is the view-dependent color, modeled with spherical harmonics associated with Gᵢ and αᵢ are the blending weights. The ray-Gaussian intersection formulation allows for depth distortion and normal consistency regularization, which improves the geometry of the 3D scene.

Regarding 3D feature fields, similar to Equation (A), features or segmentation labels can be rendered through the same alpha blending by replacing each Gaussian's color by the feature or segmentation label assigned to the Gaussian. However, this may involve assigning to each Gaussian G; a feature, which in may be computationally costly, especially for high dimensional features. To avoid this, instead of associating independent features to each Gaussian, the present disclosure uses a feature field parametrized by the triplane grid illustrated in FIG. 11 (1132). The triplane 1132 is centered at the origin of the world coordinate space and includes three two-dimensional orthogonal planes Hxy, Hxz, Hyz∈ [symbol] ^{RR}, where R is the resolution of the triplane grid 1132. For simplicity, we will also denote by Hxy, Hxz, Hyz∈ [symbol] ^{RRD} (and use them interchangeably) the three corresponding feature tensors, where D is the dimensionality of the feature space to learn.

To compute the volumetric feature gᵢ associated with a 3D Gaussian Gᵢ from the triplane, the module 1108 functions as follows. The module 1108 projects (e.g., renders) the 3D Gaussian Gᵢ onto the three planes and computes for the three resulting 2D Gaussians

$${G}_{i}^{x y} , {G}_{i}^{x z} , {G}_{i}^{y z}$$

three corresponding features

$${g}_{i}^{x y} , {g}_{i}^{x z} , {g}_{i}^{y z}$$

by applying an RPF kernel parametrized by the 2D Gaussians as discussed further below. The three grid features are averaged yielding the volumetric feature

$${g}_{i}^{3 D}$$

associated with the Gaussian Gᵢ. This representation, called Gaussian Splatting Feature Field (GSFFs), enables the features to be scale-aware, as 3D Gaussians with large spatial span will aggregate feature information over a large area within the grid, and small Gaussians over smaller areas. Further advantages of the GSFFs representation are: 1) they allow sharing information between Gaussians based on overlapping projections onto the planes as the Gaussian features are optimized interdependently through rasterization, and 2) the field can be queried from any 3D position making it suitable for 3DGS splitting and merging mechanisms.

Self-supervised training is performed by the training module 404. An aim is to perform pose refinement based on aligning pixel level 2D encoded features from the image with 3D rendered features. Hence it is important for these feature to be locally discriminative and robust to viewpoint changes. Speaking more formally, the GSFFs feature field is learned/trained jointly with the encoder module 1104 such that when rendering, at pose P, a feature map F_{3D} from the feature field is aligned with the corresponding 2D feature map F_{2D} of the image I associated to the pose P. The rendered feature map F_{3D} is obtained with alpha blending similarly to equation (A) where for each pixel u, we replace cᵢ with

$${g}_{i}^{3 D} .$$

To align F_{3D} and F_{2D}, the training module 404 trains the model in a self-supervised manner with a contrastive loss, such as described by the equation

$$L\_NCE = - 1 / 2 HW {\sum }_{-} ( u ∈ i ) log ( \frac{{exp ( {F}_{u}^{3 D} \cdot \frac{{F}_{U}^{2 D}}{τ} )}^{2}}{z} ) \qquad ( B )$$

where τ is a predetermined temperature parameter, andZ is a predetermined normalizing factor, which is discussed further below.

To better align the features and prepare the transition from features to segmentations, the feature space may be structured around a set of classes. To that end, the feature field may be clustered, 3D prototypes may be derived, and an auxiliary contrastive loss may be applied to enforce that corresponding pixel aligned 2D extracted and 3D rendered features are close to the same prototypes in the feature space.

The set of feature prototypes may best encode the spatial prior reflecting the Gaussian cloud structure. One example for generating the set of prototypes is to apply spectral clustering on a matrix containing pairwise distance between Gaussian centers. However given the high number of Gaussians, this may become intractable. Therefore a Delaunay triangulation of the Gaussian centers may be applied, which yields a graph that already captures local geometric information. Delaunay triangulation is described in Boris Delaunay, Sur la sphère vide. A la mémoire de Georges Voronoï . . . , (6): 793-800, 1934, which is incorporated herein in its entirety. The eigenvalues and eigenvectors can be computed from the Laplacian of the sparse adjacency matrix derived from the graph. The resulting eigenvectors, one for each Gaussian G, are clustered into K groups, which assigns each 3D Gaussian Gᵢ. to a cluster k. To build the representative feature (cluster prototype) pk for each cluster we simply average the volumetric features g. of all Gaussians belonging to cluster k.

Regarding a prototypical loss, the prototypes implicitly define “classes” and they are used to maximize intra-class compactness and inter-class separability within the feature space and infuse spatial priors. Given a batch of N pairs of pixel-aligned rendered/encoder features

$$\{ {F}_{u}^{3 D} , {F}_{u}^{2 D} \} ,$$

the training module 404 may associate one prototype pₖ per feature pair and target enforcing both features to be close to the prototype. The training module 404 may therefore train based on minimizing the following prototypical contrastive loss:

$${L}_{PRO} = - \frac{1}{N} {\sum }_{n = 1}^{N} log ( \frac{{exp ( {F}_{n}^{3 D} {p}_{n}^{t} \cdot \frac{{F}_{u}^{2 D} {p}_{n}^{t}}{τ} )}^{2}}{B} )$$

where

$${F}_{n}^{3 D} , {F}_{u}^{2 D}$$

are the features corresponding to the pixel uₙ, pₙ is the prototype assigned to them, τ is the predetermined temperature parameter and B is a predetermined normalizing factor, which is discussed further below. To compute the associations over the batch of feature pairs, the training module 404 may use an optimal transport procedure based on the Sinkhorn-Knopp algorithm.

For multi-view consistency, the rendering depends on the blending weights and the way the ray traverses the Gaussian. Hence rendered features may vary across viewing angles (e.g., different camera points of view). In order to encourage multi-view consistency (e.g., consistency between different points of view) of both the encoder and the feature field and to make generalizable our features to out-of-distribution views, the present disclosure may align features belonging to different views but associated to the same 3D points. To that end, given a pixel correspondence (u, v) between two images/and Î in the scene—along with there encoder/rendered features {F^{3D}, F^{2D}}, {\hat{F}^{3D}, \hat{F}^{2D}}, the training module 404 may replace (e.g., randomly) in L_{NCE} and L_{PRO} a subset of the pixel aligned feature pairs

$$\{ {F}_{u}^{3 D} , {F}_{u}^{2 D} \} by \{ {\hat{F}}_{v}^{3 D} , {F}_{u}^{2 D} \} or \{ {F}_{u}^{3 D} , {\hat{F}}_{v}^{2 D} \} .$$

The training module 404 may extract the correspondences without extra supervision with the following procedure.

Given a training image I with pose P and rendered depth D, the training module 404 may generate a random pose \hat{P} within a predetermined distance of P. The training module 404 may render the image Î, depth \hat{D} and features \hat{F}^{3D} from the scene at pose \hat{P} and use the rendered image Î to extract the 2D feature map \hat{F}^{2D}. Then, for a randomly sampled set of pixels u in I, the training module 404 may backproject the set using D and reproject it in Î, yielding the pixel v in the rendered image. Then, we backproject v using \hat{D}, into the 3D and reproject it to I. If the pixel distance between u and the reprojected v fall within a predetermined threshold, the training module 404 may consider the pair (u, v) as a valid correspondence. The training module 404 may otherwise rejected the pair.

After training, the feature space along with the 3D Gaussians may be used for pose refinement by finding the pose that minimizes feature-metric errors between 2D extracted query features and 3D rendered features rendered from the aforementioned pose. In particular, given a query image whose pose is unknown, the (trained) encoder module 1104 may first extract its 2D feature map of the image F^{2D}. Second, a retrieval module 1136 retrieves the closest database image with a global descriptor (the systems and methods described herein are agnostic to the global descriptor used) and uses the pose Pinit of the retrieved image as initialization. From Pinit, the rendering module 1124 renders the feature map F^{3D} from GSFFs. Feature inconsistencies between the two feature maps are iteratively minimized with regard to the pose by the module 1128, such as using the equation:

$$P = {min}_{P ∈ S E ( 3 )} {‖ {F}^{2 D} - {F}^{3 D} ( P , G ) ‖}_{2}^{2} D )$$

where the pose is parametrized on SE(3) (differentiable manifold) and updates are done on the Lie algebra se(3) by backpropagating explicitly through the rasterizer/rendering module 1124. At each refinement iteration, the pose is updated and features are rendered from this updated pose. The rendering module 404 may repeat and minimize the equation (D) objectives until convergence (e.g., the value is less than a predetermined value).

Regarding the privacy-preserving nature of the GSFFs, due to the clustering and subsequent prototypical formulation adopted in GSFFs, the model may be privacy-preserving. Privacy preserving may be described as the inability to recover texture/color information and fine level details. Having coarse geometric information may not violate privacy. Therefore, the high-dimensional features gᵢ may be replaced by a single segmentation label and after the model is trained, for each for each Gaussian Gᵢ color information may be removed. Kept may be only the segmentation label and the geometric alpha blending weights. At inference the rendering module 1124 may render segmentation maps that are used for segmentation-based pose refinement.

Features may be converted to segmentations by assigning them to the set of prototypes. Any Gaussian feature gᵢ or encoder feature fᵢ can be assigned to a prototype pₖ by the likelihood of the feature belonging to the cluster k defined by

$${l}_{i k}^{3 D} = \frac{exp ( {g}_{i}^{T} {p}_{k} )}{{\sum }_{{k}^{′}} exp ( {g}_{i}^{T} {p}_{k}^{′} )} .$$

The resulting scores form a pseudo-logits vector Iᵢ may be rendered by the rendering module 1124 with alpha-blending using equation (A), where color is replaced by the scores. Similarly, encoder features may be assigned with

$${l}_{i k}^{2 D} = \frac{exp ( {f}_{i}^{T} {p}_{k} )}{{\sum }_{{k}^{′}} exp ( {f}_{i}^{T} {p}_{k}^{′} )} .$$

While the prototypical learning framework induces relatively well aligned encoder/rendered assignments, the localization accuracy can further be improved by learning to directly predict the 2D segmentations. Therefore, during training, the training module 404 may include a classification head on top of the encoded features that learns to output the segmentation map S^{2D} directly from the images. To train the segmentation head (encoder module) and to further refine the features in a self-supervised way, we the training module 404 may perform the training based on additionally (in addition to equations B and C) minimizing the cross-entropy loss using the equation

$${L}_{CE} = - {\sum }_{u ∈ I} {1}_{u} \cdot ( log ( {S}_{u}^{2 D} ) + log ( {S}_{u}^{3 D} ) ) \qquad ( E )$$

where S^{3D} denotes the segmentation map with rendered pseudo-logits

$${l}_{i k}^{3 D} ,$$

1ᵤ is the one hot vector corresponding to the prototype label associated to the pixel u, using the same associations as in the prototypical contrastive loss encouraging consistency between the features and segmentations.

After training, potentially privacy-sensitive information is removed from the 3D Gaussian model (spherical harmonic, feature fields) as neither photometric information nor features are required for the privacy-preserving localization. The pseudo-logits obtained from the assignments may still contain too much information, therefore instead may be stored are assignments in the form of a single label per Gaussian Gi, k*=argmaxk(lᵢₖ). After this labeling, the triplane GSFFs feature field and the prototypes are subsequently removed. As such the 3D models include only geometric (Gaussians without color information) and segmentation information (cluster labels) effectively increasing the level of privacy. Furthermore storing only the cluster label makes the storage of the 3D representation orders of magnitudes smaller compared to storing features.

Given a pose P, segmentation maps can be rendered by the rendering module 1124 by alpha-blending (via Eq. (A)) from one-hot vectors 1ₖ (corresponding to label k), yielding

$${S}_{P}^{3 D} .$$

Given an image, 2D segmentation maps S^{2D} are directly obtained through the segmentation head. The localization pipeline is described above yet minimization of the segmentation inconsistencies between the segmentation labels is performed instead of features:

$$P = {min}_{P ∈ S E ( 3 )} CE ( {S}^{2 D} , {S}_{P}^{3 D} ) \qquad ( F )$$

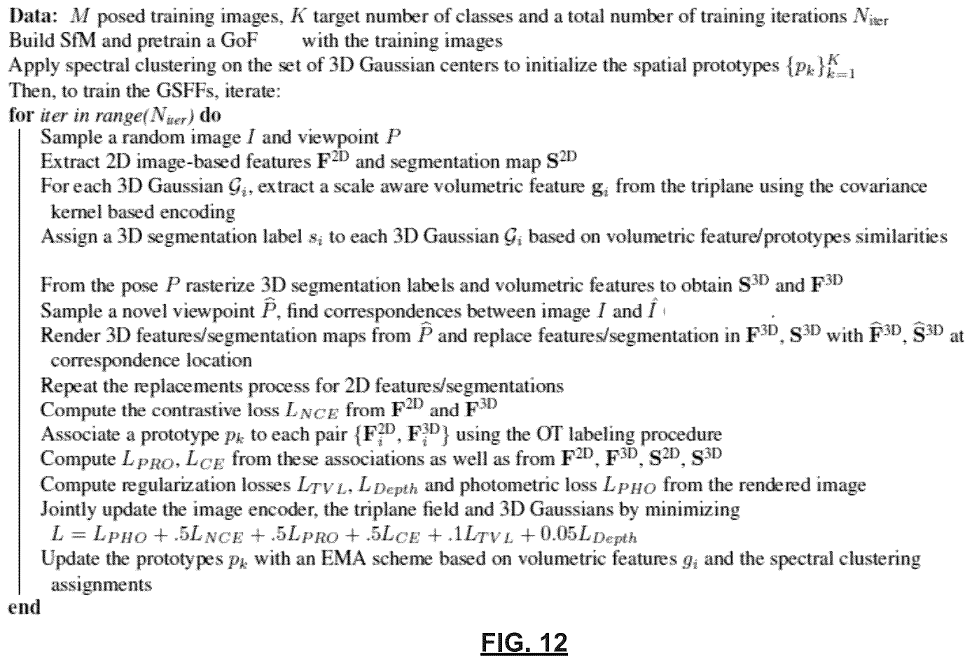

Example pseudo code (algorithm) for the training described herein is provided in FIG. 12.

Line 1 involves initializing the 3D Gaussians from SfM and pretraining the Gaussian model.

Line 2 involves creating the spatial prototypes (cluster centers).

Line 5 involves sampling a random training image with its pose.

Line 6 involves extracting image features and segmentations from the encoder module 1104.

Line 7 involves extracting one feature per 3D Gaussian with the triplane 1132.

Line 8 involves assigning one label per 3D Gaussian with the labelling module 1120.

Line 9 involves rendering 3D features and segmentations with the rasterization module 1124.

Line 10 involves sampling a new pose and finding correspondences between the image associated to this pose and the current training image.

Line 11 involves swapping features between images at correspondence locations.

Line 12 involves swapping segmentations between images at correspondence locations.

Line 13 involves computing the contrastive loss.

Line 14 involves associating one label (prototype index) per pair of pixel aligned image features/rendered features.

Line 15 involves computing the prototypical contrastive loss and the cross entropy loss.

Line 16 involves computing regularization losses.

Line 17 involves backpropagating gradients from the global loss (weighted summation of individual losses) with respect to modules 1104/1132/116.

Line 18 involves updating the spatial prototypes (cluster centers) with an EMA scheme.

More details regarding the derivation of the losses described above will now be provided. As discussed above, the training is self-supervised to align the feature maps F^{3D} and F^{2D}. Therefore, during training at each step the alignment module 1128 samples N pixels in these maps to be aligned.

Denote the N corresponding pairs of pixel aligned extracted/rendered features by

$${\{ {F}_{n}^{2 D} , {F}_{n}^{3 D} \}}_{n = 1}^{N} .$$

The contrastive loss has two terms. The first one is a term enforcing similarity of 2D extracted features with regard to 3D rendered features, and the second term is enforcing similarity of the 2D rendered features with regard to 3D extracted features:

$$L \_ NCE = - 1 / {N Σ}_{-} ( u ∈ i ) log ( \frac{{exp ( {F}_{u}^{3 D} \cdot \frac{{F}_{u}^{2 D}}{τ} )}^{2}}{{Σ}_{j = 1}^{N} {exp ( {F}_{u}^{3 D} \cdot \frac{{F}_{j}^{2 D}}{τ} )}^{2}} ) - \frac{1}{N} {\sum }_{u = 1}^{N} log ( \frac{{exp ( {F}_{u}^{3 D} \cdot \frac{{F}_{u}^{2 D}}{τ} )}^{2}}{{Σ}_{j = 1}^{N} {expF}_{u}^{3 D} \cdot \frac{{F}_{j}^{2 D}}{τ}} )$$

yielding L_{NCE} equal to:

$${L}_{NCE} = - \frac{1}{N} {\sum }_{u = 1}^{N} log ( \frac{exp ( {F}_{u}^{3 D} \cdot \frac{{F}_{u}^{2 D}}{τ} ) exp ( {F}_{u}^{2 D} \cdot \frac{{F}_{u}^{3 D}}{τ} )}{{Σ}_{j = 1}^{N} exp ( {F}_{u}^{3 D} \cdot \frac{{F}_{j}^{2 D}}{τ} ) {Σ}_{j = 1}^{N} exp ( {F}_{u}^{2 D} \cdot \frac{{F}_{j}^{3 D}}{τ} )} )$$

From this we can derive equation (B) above where the normalization factor A is:

$$A = ( {Σ}_{u = 1}^{N} exp ( {F}_{u}^{3 D} \cdot \frac{{F}_{j}^{2 D}}{τ} ) ) {Σ}_{-} ( j = 1 ) \hat{} N exp ( F\_u \hat{} 2 D \cdot ( F \_ j \hat{} 3 D ) / τ ) )$$

Similarly, the prototypical contrastive loss has a term enforcing the similarity between 2D extracted features and the associated prototypes, and a second term enforcing similarity between 3D rendered features and the associated prototypes:

$$L \_ PRO = - 1 / {N Σ}_{-} ( n = 1 ) \hat{} N log ( ( exp ( ( F \_ n \hat{} 3 D \cdot p \_ n ) ) / τ ) ) \text{} / ( Σ\_ ( j = 1 ) \hat{} K exp ( ( F \_ n \hat{} 3 D \cdot p \_ j ) ) / τ ) ) ) - 1 / {N Σ}_{-} ( n = 1 ) \hat{} N log ( ( exp ( ( F \_ n \hat{} 2 D \cdot p \_ n ) ) / τ ) {Σ}_{-} ( j = 1 ) \hat{} \text{} K \text{} exp ( ( F \_ n \hat{} 2 D \cdot p \_ j ) ) / τ ) ) )$$

yielding L_{PRO} equal to

$$- 1 / {N Σ}_{-} ( n = 1 ) \hat{} N log ( ( exp ( ( F \_ n \hat{} 3 D \cdot p \_ n ) ) / τ ) exp ( ( F \_ n \hat{} 2 D \cdot p \_ n / τ ) ) / {Σ}_{-} ( j = 1 ) \hat{} K exp ( ( F \_ n \hat{} 3 D \cdot p \_ j ) ) / τ ) ) Σ\_ j = 1 ) \hat{} K exp ( ( F \_ n \hat{} 2 D \cdot p \_ j ) ) / τ ) )$$

which simplifies equation (C) with the normalization factor B of

$$B = ( {\sum }_{j = 1}^{K} exp ( {F}_{u}^{3 D} \cdot \frac{{p}_{j}}{τ} ) ) ( {\sum }_{j = 1}^{K} exp ( F {u}_{2 D}^{} \cdot \frac{{p}_{j}}{τ} ) )$$

Now detailed is the optimal transport association function discussed above. Given a batch of N pairs of pixel aligned extracted/rendered features

$${\{ {F}_{n ′}^{2 D} , {F}_{n}^{3 D} \}}_{n = 1}^{N}$$

and a set of K prototypes P∈ [symbol] ^{K×D}, an aim is to associate a prototype per pair of pixel aligned features.

This association operation is configured to respect two criteria: 1) a single prototype is associated per pair of features so that the extracted/rendered features are pushed toward the same “class” in the feature space; and 2) predictions are as balanced as possible to avoid collapse. To solve these constraints, optimal transport may be used, where the problem is framed as finding a mapping Q∈ [symbol] ^{K×D} between pixels and prototypes that maximizes the feature similarity between the pairs of features and the prototypes. The joint feature/prototypes similarities may be described by S∈ [symbol] ^{K×D} as:

$$S \_ kn = exp ( F \_ n \hat{} 2 D \cdot p \_ k + F \_ n \hat{} 3 D \cdot p \_ k ) / τ ) / C with \\ C = {Σ}_{-} K exp ( F \_ n \hat{} 2 D \cdot p \_ k / τ ) ) {Σ}_{-} K exp ( F \_ n \hat{} 3 D \cdot p \_ k ) / τ ) )$$

The following objective may be used where Q maximizes the joint feature/prototypes similarities S:

$${max}_{Q ∈ U ( \frac{1}{N} , \frac{1}{K} )} Tr ( {Q ( - log S )}^{t} ) + λ h ( Q ) ere$$

the entropy term h(Q) encourages balanced predictions while using joint extracted/rendered feature prototypes similarities yields a single association per feature pair. If Q is relaxed such that it belongs to the transportation polytope U

$$U ( \frac{1}{N} , \frac{1}{K} )$$

Q can be efficiently computed with the iterative Sinkhorn-Knopp algorithm, which is described in M. Cuturi, Sinkhorn Distances: Lightspeed Computation of Optimal Transport, in NeurIPS, 2013, which is incorporated herein in its entirety. The final associations Γ∈ [symbol] ^{N} are obtained with Γ=argmaxk(Q).

Regarding projecting and/or rendering 3D Gaussians onto the Triplane, the following explains how a volumetric feature for each 3D Gaussian is derived from the triplane grid. The triplane grid is centered at the origin of the world coordinate space and it includes three orthogonal 2D planes H_{xy}, H_{xz}, H_{yz}∈ [symbol] ^{D×R×R}, D being the triplane feature dimension and R the resolution of the grid.

A projection module 1110 may project (e.g., render) each 3D Gaussian Gᵢ onto these planes and derive three Gaussian kernels

$${G}_{i}^{xy} , {G}_{i}^{xz} , {G}_{i}^{yz}$$

from the projections, which the extraction modules uses to obtain scale aware volumetric features

$${g}_{i}^{3 D} .$$

To obtain the xy feature, the system proceeds as follows. Note that xz and yz features are obtained similarly or the same way. Let m; be the center of Gᵢ and Σᵢ be its covariance matrix. The projection module 110 may first project (e.g., render) the center on the plane yielding

$${m}_{i}^{xy} .$$

The projection module 1110 may perform orthographic projection of the covariance matrix to obtain

$${\sum }_{i}^{xy} .$$

A grid of dimension 5 by 5 may be defined and centered on

$${m}_{i}^{xy} .$$

On the plane xy of the triplane, the projection module 1110 may use the coordinates of the points in the grid u to define the following Gaussian kernel:

$${G}_{i}^{xy} ( u ) = \frac{1}{z} exp ( - \frac{{{u 〚 ( \sum 〛}_{i}^{x y} )}^{- 1} {u}^{t}}{2} )$$

where Z is a predetermined normalization constant. The projection module 1110 may query the feature plane Hxy for each point uₖ in the grid and apply the Gaussian kernel on the queried features. This yields a D-dimensional feature

$${g}_{i}^{xy}$$

associated to

$${G}_{i}^{xy} .$$

This is repeated for H_{xz},

$${G}_{i}^{xz}$$

### and H_{yz},

$${G}_{i}^{yz} .$$

The resulting features

$${g}_{i}^{xy} , {g}_{i}^{xz} , and {g}_{i}^{yz}$$

are summed by the projection module 1110 to obtain the volumetric feature

$${g}_{i}^{3 D} .$$

Additional information on the training will now be described. The training module 404 may perform densification and pruning operations based on image space gradients are applied until a predetermined iteration, such as 15000. The densification interval may be set to a predetermined range of iterations, such as to 600 iterations until iteration 7500, and reduced to a predetermined number of iterations after, such as 400 iterations.

To facilitate the convergence of the 3D Gaussian model, the training module 404 may train on images downscaled by a predetermined factor (e.g., 4) until a predetermined iteration, such as iteration 7500. From a predetermined iteration on, such as iteration 15000, geometric regularization losses may be applied by the training module 404 until the end of the training. The triplane learning rate is set a predetermined rate, such as to 7e-3, while the encoder learning rate is set to a predetermined learning rate, such as 1e-4. GSFFs are optimized with an optimizer, such as the Adam optimizer. The prototypes are updated by the training module 404 based on an exponential moving average (EMA) scheme with a predetermined alpha value, such as α=0.9995, after each training iteration. The temperature T for the contrastive losses is set to a predetermined value, such as 0.05. In the Multi-view consistency paragraph from, the pixel reprojection threshold is set to a predetermined value, such as 2 for the fine level, and to a predetermined value, such as 4, for the coarse level. The coarse encoder may include, for example, the Dinov2 encoder followed by projection convolutional layers (e.g., convolutional layer with kernel size 1 to reduce the dimension, while maintaining the resolution) and a ConvNeXt block. The Dinov2 encoder is described in M. Oquab, et al., Dubiv2: Learning Robust Visual Features Without Supervision, arXiv preprint arXiv:2304.07193, 2023, which is incorporated herein in its entirety. ConvNext blocks are described in Z. Liu, et al., A convnet for the 2020s, in Proceedings of the IEEE/CVF conference on computer vision and pattern recognition, pp. 11976-11986, 2022, which is incorporated herein in its entirety. The fine encoder may include shallow convolutional layers followed by a ConvNext block. The segmentation module may include convolutional layers with ReLU activations and Group-Norm normalization.

To reduce running time and the memory footprint, training images may be rescaled by the training module 404, for example such that image width is a predetermined dimension (e.g., 1024 pixels, 480 pixels, etc.). In various implementations, the original image resolution may be used for one or more training datasets. During visual localization, the same image resolution may be used as the one used during training. In various implementations, the training images may include illumination changes. As such, an embedding per training image may be learned to capture these illumination changes during the training. These embeddings may only be used during training to learn the scene representation. In various implementations, the training module 404 may mask out the sky and pedestrians in training images. The masks may be extracted by the training module 404 using a segmentation model. In various implementations, the training images may include both day and night images with large illumination changes. In various implementations, the training module 404 may apply CLAHE normalization on training images.

For visual localization, and more specifically for the pose refinement, an optimizer such as the Adam optimizer, may be used. Predetermined coarse and fine learning rates may be applied. In various implementations, different coarse and fine learning rates may be used for different training datasets. Rendered areas with distortion greater than a predetermined amount may be masked out during refinement.

Now the influence of the number of classes/prototypes on both the feature- and the segmentation-based variants will be discussed. As an example, a feature dimension of 16 and 34 segmentation classes may be used. As both features and segmentations may be rendered in the same variable (each channel is independently rendered), the rasterization module 1124 may be compiled with a fixed rendering dimension of 50 (16+34) yielding a good compromise between rendering speed and discriminative power.

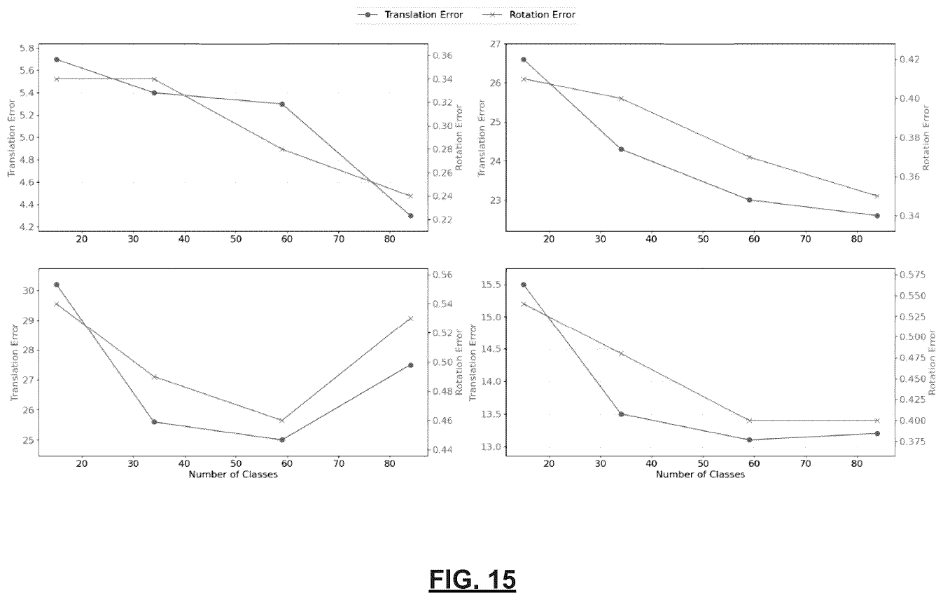

A feature dimension of 16 and varying the number of classes will now be discussed. We the rasterization module 1124 may be compiled with a map dimension of 100 and then training and evaluation of the model with 84 classes, 59 classes, and 15 classes will be discussed. FIG. 15 includes example graphs of median translation and rotation errors different training datasets against the number of classes of each model. The graphs illustrate that using only a few classes may not be sufficient because the lack of discriminative power. Increasing the number of classes first yields a significant gain, however above a certain number of classes a drop in accuracy may be observed. This may be due to over-clustering and hence increased difficulty for the representation to converge during the training. Overall, the number of classes should be high enough to make the segmentation discriminative enough for localization, but not too high to ensure the convergence. Naturally, larger scenes with diverse viewpoints may involve more classes, while for simpler scenes may be beneficial to consider less classes.

The model may benefit from the increased number of classes as, during training, gradients are backpropagated from segmentation and feature maps and L_{PRO} implicitly uses the prototypes.

Improving the initial pose results in higher final localization accuracy. This also involves less refinement steps to converge. Performances on high resolution images is slightly better than on low resolution images, but this comes at a higher inference cost. Running time can be decreased by decreasing refinement steps. A loss in performance is relatively small conditioned that we start from a good initialization. This suggests that localization speed can be increased by combining low and high resolution based refinement and stopping the optimization earlier.

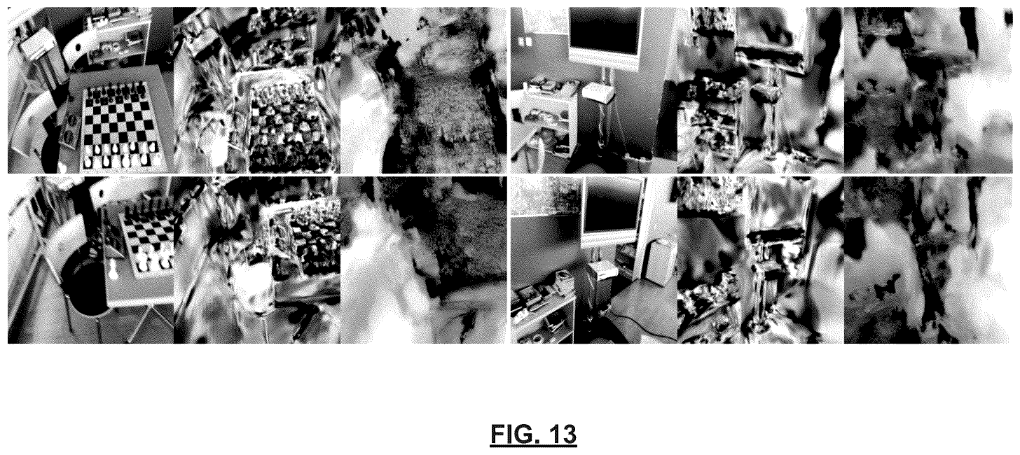

FIG. 13 includes four example sets of images (top left, top right, bottom left, bottom right). In each set, left to right is an original image, an inversion attack from rendering the features produced according to the systems and methods described herein (middle) and rendering from the segmentations (right).

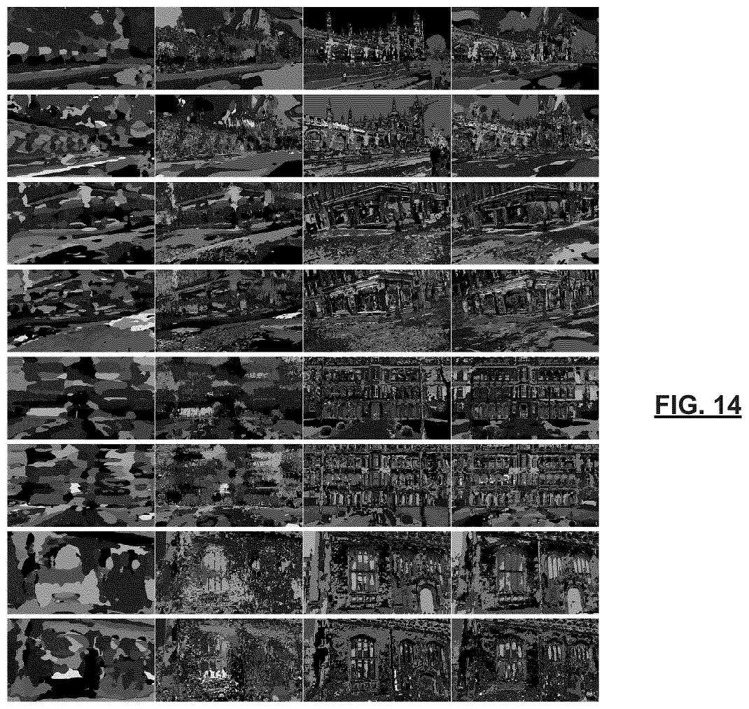

FIG. 14 includes example sets of images. From left to right, coarse encoder/rendered segmentation, fine encoder/rendered segmentation. Comparison between models trained with 34 classes (line 1/3/5/7) and models trained with 84 classes (line 2/4/6/8). 2D extracted and 3D rendered segmentations are well aligned which allows for accurate privacy preserving visual localization.

VL methods, can be distinguished based on how they represent the scene, e.g., explicitly through a (e.g., sparse) point cloud or a collection of images or implicitly through the weights of a neural network. Due to their rich representation of a scene, NeRF-based systems and methods may be used for VL. While NeRFs offer high-quality novel view synthesis, they may inadvertently encode fine scene details, which may raise privacy concerns when deployed in cloud-based localization services as sensitive information could possibly be recovered.

The present disclosure describes a protocol to assess privacy-preservation of NeRF-based representations. NeRFs trained with photometric losses may store fine-grained details in their geometry representations, making them vulnerable to privacy attacks even if the head that predicts colors is removed. This present disclosure also describes systems and methods for ppNeSFs (Privacy-Preserving Neural Segmentation Fields). These are a NeRF variant trained by the training module 404 with segmentation supervision instead of RGB images. The training module 404 learns the segmentation labels in a self-supervised manner, ensuring they are coarse enough to obscure identifiable scene details while remaining discriminative in 3D. The resulting segmentation space of ppNeSF can be used for accurate visual localization, yielding state-of-the-art results among rendering based and privacy-preserving methods.

As discussed above, VL is a core component of self-driving vehicles and autonomous robotic actuation and refers to the task of estimating the 6 degree of freedom (DoF) pose of a camera that captured an image using the image. Generally speaking, VL approaches compute the pose by aligning the image with a representation of the scene or by matching sparse image points with a representation of the scene and solving a geometric problem. Examples of representations include 3D Structure-from-Motion (SfM) point clouds, a database of images with known intrinsic and extrinsic parameters, or the weights of neural networks. NeRFs may also be used for the underlying 3D scene representation. Regarding the use of NeRFs for the representation, either matching or aligning features rendered from NeRFs may be used. Contrarily to sparse SfM models, these methods benefit from the dense 3D nature of NeRFs and their ability to render consistent color, geometry, or additional information such as segmentation labels or features.

As in practice, large-scale VL services are very likely to be deployed in the cloud, so there is an interest in maintaining privacy. Privacy may be described as the inability to retrieve sensitive information from a scene, such as pictures, documents, or texture details that could reveal personal information. Here, privacy may be described through the lack of capability (i.e., the inability) of vision-language models (VLMs) to describe the content of a scene. This evaluation focuses on higher-level semantic and/or segmentation structures and descriptions, as a strong step towards identifying privacy sensitive fine details.

Furthermore VLMs provide a strong proxy for how an artificial intelligence (AI) system perceives and interprets visual information, making them a relevant benchmark for assessing privacy risks. The present disclosure involves localization with 3D representations in the context of neural implicit fields. An evaluation protocol is described to assess the degree of privacy preservation offered by neural implicit representations.

The present disclosure details an inversion attack that reconstructs images by inverting rendered internal representations of such fields. Quality of these reconstructions may be assessed using perceptual metrics and also examine how much semantic and/or segmentation information can be recovered from the reconstructed images through comparison of reconstructed image descriptions provided by a strong vision-language model. The proposed privacy attack exposes the privacy liability of radiance fields trained by optimizing them with RGB supervision: Fine details can already be stored in the part of the representation designated for raw geometry, which is used in implicit neural field-based localization for pose estimation. Thus, simply removing the branch predicting colors after training does not guarantee privacy.

The ppNeSF systems and methods described herein provide visual localization based on neural fields and are based on segmentation labels corresponding to non-injective mappings between RGB pixels and object instances in the scene and contain less detailed information than RGB images. Segmentation label supervision is used for the training, reducing the retention of high-frequency information and sensitive details backpropagated within the neural implicit field. Segmentation label targets are used as supervisory signals to simultaneously refine the geometry of the neural field and establish a unified segmentation space connecting the 3D neural scene representation with a 2D image encoder. This allows for localization through the alignment of segmentation maps. The targets are determined by the training module 404 in a self-supervised manner with an optimal transport (OT) labelling procedure within a joint 2D/3D hierarchical feature embedding space which ensures their robustness, viewpoint consistency, and local discriminativeness.

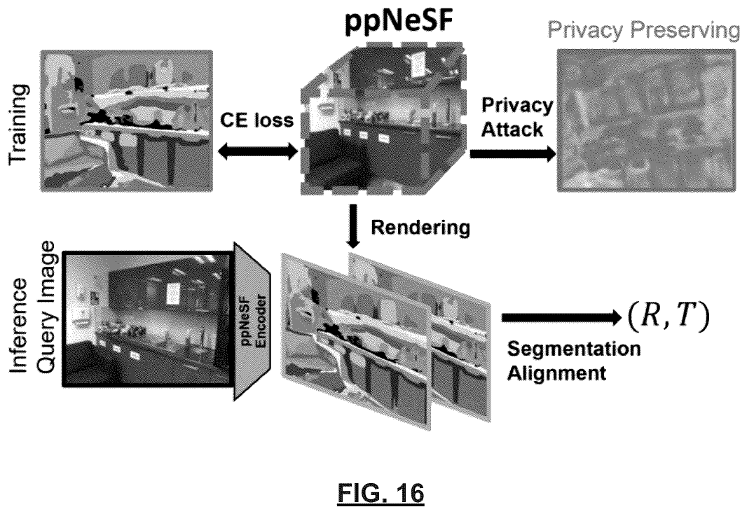

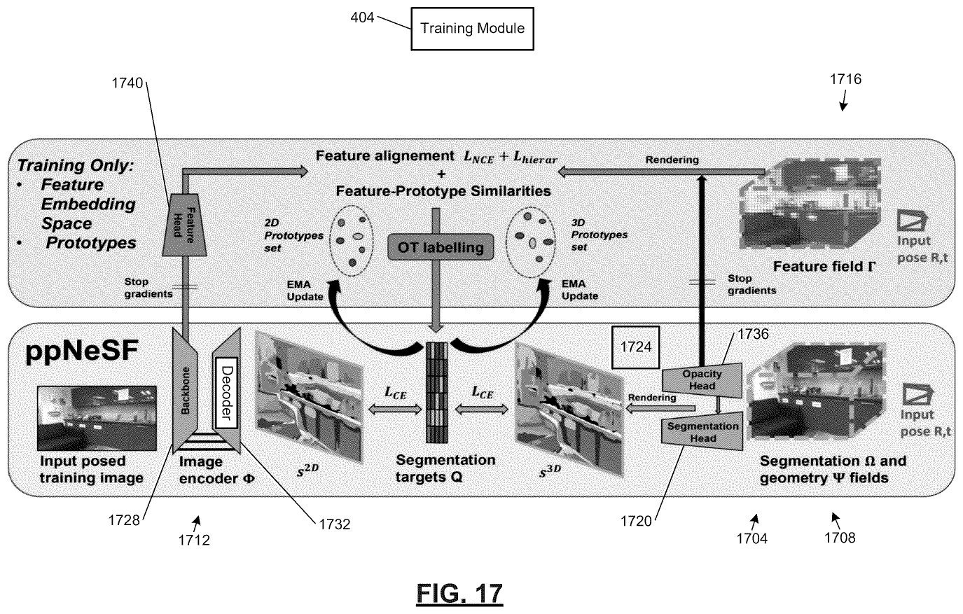

FIGS. 16 and 17 includes a functional block diagram of an example implementation of a ppNeSF system and a training system. NeRF optimized with photometric loss inherently store fine-grained scene details making them susceptible to privacy attacks. The ppNeSF system replaces the use of RGB supervision with segmentation based training, which ensures that only higher level structural information is stored by the scene representation. The ppNeSF system enables accurate visual localization by aligning segmentation maps through coarse to fine pose refinement.

Camera pose refinement solves VL by minimizing, with regard to the pose, the difference between the query image and a rendering obtained by projecting and/or rendering the scene representation using the current pose estimate. The pose is iteratively refined from an initial pose estimate. Similarly, deep features may be leveraged by minimizing the differences between features extracted from the image and projections of features stored in the scene. Alternative to the use of SFM models such as implicit fields, 3D Gaussians, or meshes may be used to store the features.

Regarding VL using neural implicit fields, view synthesis of NeRFs may be used to perform pose refinement through photometric alignment, where the optimization is performed by back-propagation through the neural field. Instead of direct photometric alignment, pose estimation by feature-metric alignment or by feature matching+PnP can be performed either by training a feature field to replicate features provided by a pre-trained 2D encoder or by jointly training a 2D encoder with the feature field in an unsupervised manner.

Given a (sparse) set of features and their 2D positions, it may be possible to recover the original image via an inversion attack. By extension, detailed and recognizable images of a scene can be obtained from sparse 3D point clouds (where each point is associated with a feature) by reprojecting and/or rendering these 3D points with their descriptions on the image plane.

To prevent inversion attacks, visual VL based on geometric obfuscation may modify scene representations by replacing 2D or 3D positions with lines or planes or by permuting point coordinates. Yet, it may be possible to (approximately) recover the underlying point positions. Other VL may be performed with features or representations that are harder to invert. For example, replacing high-dimensional descriptors with segmentation labels may prevent such inversion. In the context of NeRF-based facial reconstruction, privacy may be attained by using gradients of RGB images as supervision instead of RGB images.

The present disclosure involves making neural implicit field privacy-preserving. Segmentation labels are used by the training module 404 to supervise implicit neural fields as the segmentations aim to remove details and whole regions get assigned the same label thus removing information stored in the resulting model (scene representation). Instead of aligning deep features, the present disclosure (location and pose module 110) determines pose by hierarchical alignment of 2D extracted/3D rendered segmentation maps. The present disclosure learns both consistent 3D/2D scene segmentations jointly with the 3D scene model.

An example inversion attack will now be discussed along with an evaluation protocol to assess the degree of privacy of neural implicit fields (NIFs) via such an attack. NeRFs are a type of NIFs (NIFs do not necessarily encode color/radiance information) where for any 3D point, a first MLP module predicts a volumetric density and a second MLP module (conditioned on the first one) predicts a color which can be rendered. Optimizing NeRFs with a photometric loss during training by the training module 404 leads to texture and fine information being embedded in the geometric part of the model, and even removing the color prediction head after training may not make NeRFs privacy preserving.

Regarding the attack, the internal representation of NeRFs may include sensitive information compromising privacy. The output of the first MLP module in 3D space is the internal representation. However, any component optimized during training and used for geometry prediction can be used in our inversion attack. We aim at extracting the information contained in these rendered internal representations by training an inversion model that takes the rendered internal representations as input and reconstructs a grayscale image corresponding to the viewpoint where those features were rendered. The inversion module may reconstruct the grayscale images—instead of RGB—to increase the generalization power of the model across datasets and to make the model robust to color variations of certain objects. The inversion model is trained by the training module 404 on scenes from one dataset and evaluated on scenes from another unseen dataset. Training details are provided further below.

Regarding the privacy-preserving NeSF (ppNeSF) architecture, the ppNeSF architecture involves neural implicit field encoding 3D segmentation and geometry which is optimized with segmentation supervision. FIG. 17 includes a block diagram illustrating an example of the architecture and illustrates a portion of training. Training of the architecture will be discussed further below. Hierarchical regularization and uncertainty estimation may be used to further enhance the discriminative power of the segmentation.

The ppNeSF architecture (module) includes three modules: a Geometric Field module 1704 ψ, a Segmentation Fields module 1708 Ω conditioned on the Geometric field module 1704, and an Image Encoder module 1712 φ. To enable training from scratch, the ppNeSF module also includes a Feature Field module 1716 Γ. In various implementations, the feature field module 1716 is used during training and not used after training during inference.

The geometric field module 1704 (ψ) may include or be based on the ZipNeRF architecture. The ZipNeRF architecture is discussed in J. Barron, et al., Zip-NeRF: Anti-Aliased Grid-Based Neural Radiance Fields, in ICCV, 2023, which is incorporated herein in its entirety. In various implementations, another NIF model could be used as the geometric background model.

Given a ray emanating from a pixel of a camera, a set of 3D points is sampled by the geometric field module 1704 on the ray. The geometric field module 1704 predicts colors cᵢ,i∈{1, . . . , n} for each point and renders the color C of the pixel through alpha composition via

$$\hat{C} = {\sum }_{i = 1}^{n} {T}_{i} {α}_{i} {c}_{i} .$$

Here, Tᵢ is the accumulated transmittance at sample i and αᵢ is the discrete opacity value at sample i. To ensure privacy, no photometric supervision is used, therefore no RGB branch is used. Using alpha composition as above, other representations such as segmentation logits or features may also be rendered. Segmentation labels as the sole supervision may be relatively unconstrained, so the training module 404 may train the ppNeSF module further based on an auxiliary depth loss to provide further geometric priors. The geometric field module 1704 includes a first MLP module.

Regarding the segmentation field module 1708 (Ω), a segmentation head (module) 1720 maps each 3D point to a segmentation logit. Segmentation logits along a ray may be rendered by a rendering module 1724 by alpha composition yielding a segmentation map S^{3D}. The segmentation head module 1720 is conditioned on the first MLP module of the geometry field module 1704 allowing geometry optimization through segmentation supervision.

The image encoder module 1712 (φ) may be a 2D image encoder and include a feature backbone 1728 having the transformer architecture and output a pixel-aligned feature map and a decoder module 1732 that take as inputs multi-resolution features and outputs a pixel-aligned segmentation map S^{2D} and an uncertainty map u^{2D}. The decoder module 1732 may be a segmentation head in various examples.

The feature field module 1716 (Γ) is used during training to steer the learning/raining of parameters of the segmentation field module 1708 Ω. The feature field module 1716 is deleted and not used during inference/real world use of the ppNeSF module for visual localization to maintain a privacy preserved representation of the scene. The 3D feature field is used to render volumetric features (using the same anti-aliasing techniques as ZipNeRF) by alpha composition using the opacity weight from the geometric field module 1704 ψ. An opacity head module 1736 generates the opacity weights. Gradients are detached from these weights to avoid attaching privacy information into to the segmentation field module 1708 (Ω).

Regarding the self-supervised training, to learn aligned segmentations between the image encoder module 1712 φ and the segmentation field module 1708 Ω along with the geometric field module 1704 ψ, the segmentation classes may be defined by clustering features in a learned embedding space shared between the image encoder module 1712 and the feature field module 1716 Γ.

Below, first will be described how the shared feature embedding space is learned. Second will be described how two sets of prototypes (cluster centers) are obtained in this space. Third will be described how the training module 404 trains the ppNeSF module by alternatively deriving segmentation label targets from the prototypes/feature embeddings and using these targets in the overall learning objective to jointly optimize the segmentation field module 1708 Ω, the image encoder module 1712 φ, and the geometric field module 1704 ψ.

The training module 404 first learns a joint embedding space between the encoder module 1712 φ and the rendered features from the feature field module 1716 Γ. Given an image I with pose P, the image encoder module 1712 determines a pixel-aligned deep feature map F^{2D}∈ [symbol] ^{D×H×W}. Given a pose P, from the Feature Field module 1716 Γ, the rendering module 1724 renders a pixel aligned volumetric feature map F^{3D}∈ [symbol] ^{D×H×W} using alpha composition. An aim is to ensure that the 2D/3D feature maps are pixel-aligned, while encouraging feature discriminativeness through the following contrastive loss:

$$L\_NCE = - 1 / 2 N {\sum }_{-} ( i = 1 ) \hat{} N 〚 log ( \frac{exp ( \frac{{F}_{ui}^{3 D} {F}_{ui}^{2 D}}{τ} )}{A} 〛 〛$$

where

$${\{ {u}_{i} \}}_{i = 1}^{N}$$

are randomly sampled pixels, τ is a predetermined temperature parameter value, and A is a predetermined normalizing factor as discussed further below. In order to avoid contamination of components of the ppNeSF module with texture and color information and hence compromising privacy, the training module 404 does not backpropagate the gradients between Γ and (Ω, ψ). Embedding 2D/3D features in the same embedding space leverages the scale-awareness and viewpoint invariance of the 3D Feature Field module Γ 1716, while benefiting from the inductive biases of the transformer-based 2D encoder module 1712 φ. As segmentations targets are derived from the embedding space during inference, they also inherit these properties.

Prototypes are illustrated in FIG. 17. In this embedding space, two aligned sets of K prototypes are maintained, one for the image-based features

$${\{ {p}_{k}^{2 D} \}}_{k = 1}^{K}$$

and one for the rendered features

$${\{ {p}_{k}^{3 D} \}}_{k = 1}^{K} ,$$

with K being the number of segmentation classes. The prototypes implicitly define the latent classes in the feature embedding space and will be used to derive segmentation targets by mapping features to prototypes based on their similarities in the corresponding feature space. Since the prototypes capture the whole scene context, mapping features from a single image to the prototypes will ensure view consistent and discriminative segmentation targets. Hence, the segmentation targets derived from the prototypes provide 404 are used to optimize both the segmentation field module 1708 Ω, the geometric field module 1704 and the image encoder module 1712 φ. In other words, the training module 404 trains the segmentation field module 1708, the geometric field module 1704, and the image encoder module 1712 (e.g., jointly) based on the segmentation targets derived from the prototypes. The feature field module 1716 is optimized/trained as discussed in the previous paragraph and is not optimized with the segmentation targets derived from prototypes.

Regarding the optimization, to ensure privacy, the training module 404 may optimize the ppNeSF module through a cross-entropy loss (e.g., solely based on minimizing the cross-entropy loss). Each training iteration may include or consist of two alternating steps, computing target segmentation labels distribution Q and optimizing the loss based on these labels.

The objective function of the training may be described as follows. Given a target segmentation label distribution Q, the training module 404 may train the ppNeSF module based on minimizing the following cross entropy loss with regard to the ppNeSF parameters (the geometry ψ and segmentation Ω fields and image-based encoder φ):

$$min {\sum }_{i = 1}^{N} {\sum }_{k = 1}^{K} q ( k \vert {u}_{i} ) log ( {s}^{2 D} ( k \vert {u}_{i} ) \cdot {s}^{3 D} ( k \vert {u}_{i} ) ) X )$$

where

$${\{ {u}_{i} \}}_{n = 1}^{N}$$

is a set of uniformly sampled pixels, s(·|uᵢ) is the softmax prediction score over the K segmentation classes of the image encoder module 1712 φs^{2D} and of the rendered segmentation field Ω(s\hat{ }3D) respectively. The training enforces that both the image-based segmentations and rendered segmentations align with the same target distribution Q so that segmentation-based pose alignment may be performed after the training. The geometry of the scene is also optimized through this objective function.

To derive the target label distributions Q, at each iteration, given an input image, the training module 404 first derives a segmentation label distributions Q as follows. Using Frobenius inner product notations, the above minimization equation can be rewritten as min [symbol] Q, −logS [symbol] , where Qᵢₖ=q(k|uᵢ) and S_ki=s\hat{ }2D (k|u_i))s\hat{ }3D(k|u_i). The target distribution Q is the minimizer of this equation. By adding an entropy regularization term on Q and relaxing Q to belong to the transportation polytope, the former equation can be rewritten as an optimal transport (OT) problem where sought is a pixel to class mapping Q that maximizes an objective of the form

$${max}_{Q ∈ U ( \frac{1}{N} , \frac{1}{K} )} Trace ( {Q ( - log S )}^{t} ) + λ h ( Q ) Y )$$

Q can be efficiently computed by the training module 404 using the iterative Sinkhorn-Knopp algorithm. The resulting Q∈ [symbol] ^{N×K} is used to optimize the above minimization equation with respect to Ψ, Ω and φ.

The training module 404 determines Q based on the softmax scores obtained with feature-prototypes similarities. Thus S∈ [symbol] ^{N×K} becomes

$${S}_{ki} = \frac{exp ( \frac{{F}_{ui}^{2 D} {p}_{k}^{2 D} + {F}_{ui}^{3 D} {p}_{k}^{3 D}}{τ} )}{B}$$

with B being a predetermined normalization factor. Despite using only N sampled pixels per iteration, the training module 404 may compare the features Fᵤ with prototypes pₖ, which encapsulate the entire scene's content. This approach ensures that the resulting labels are discriminative, diverse, and viewpoint-consistent, which may be important properties for optimizing the implicit field. Finally, the training module 404 determines pixel-wise assignments as v=argmaxₖ(Q). For each class k the set of assigned pixels can be defined as A(k)={i|v(i)=k}. The training module 404 updates the prototypes using an Exponential Moving Average (EMA) based on each pixel's assignment

$${p}_{k}^{2 D} = μ {p}_{k}^{2 D} + ( 1 - μ ) ( α \frac{1}{\vert A ( k ) \vert} {\sum }_{i ϵ A ( k )} {F}_{i}^{2 D} + \frac{( 1 - α ) 1}{\vert A ( k ) \vert} {\sum }_{i ϵ A ( k )} ( {F}_{i}^{3 D} )$$

with μ being the decay factor set to 0.999 and a being a predetermined value varied according to a predetermined schedule (e.g., 0 to 0.5) over the course of the training. The 3D prototypes are updated by the training module 404 similarly. An example of EMA is described in R. Brown, Smoothing Forecasting and Prediction of Discrete Time Series, Prentice Hall, 1963, which is incorporated herein in its entirety.

Replacing photometric supervision with segmentation supervision may make the optimization of neural fields less stable. To facilitate training of the ppNeSF module, a coarse-to-fine hierarchical segmentation scheme may be used and segmentation uncertainty may be modeled by the training module 404. More details are provided below.

For the hierarchical segmentation, to capture different granularities and to provide finer complementary supervision information, a fine level of segmentation may be used. Concretely, each of the previous clusters is divided by the training module 404 into n subclusters yielding a set of K_{f}=n·K fine prototypes for 2D and 3D modalities each. A second segmentation head of dimension K_{f} is included in both the implicit segmentation fields module Ω 1708 and the encoder module φ 1712. The fine prototypes are updated by EMA by the training module 404 similar to the update of the coarse prototypes. To further promote intra-class compactness and separability within the embedding space, the training module 404 may train based on a hierarchical contrastive loss between pixel and prototypes which also enforces the hierarchy described above. In some embodiments, in hierarchical segmentation, a set of prototypes may be divided into course levels of segmentation and finer levels. The coarser levels may be aligned with finer levels.

Regarding uncertainty, the self-supervised segmentation targets are affected by uncertainty due to the labelling procedure. As they are used as the supervision signal, this can destabilize the learning process. Therefore, the encoder module 1712 is configured to predict heteroscedastic uncertainty and attenuate the cross entropy loss for uncertain samples. These uncertainties are further used during localization to down-weight ambiguous pixels.

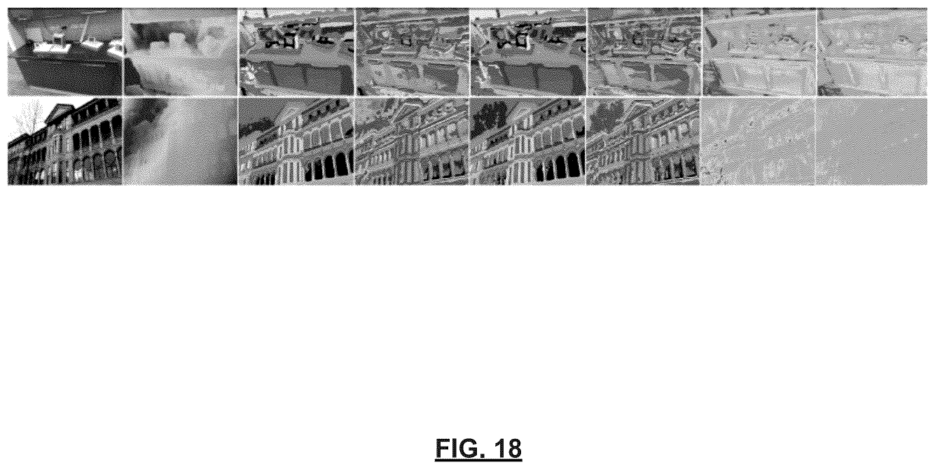

Regarding the training, the ppNeSF module is trained independently per scene. As examples, the number of coarse classes may be set to K=20 and the number of fine classes may be set to n=5 for a total number of K_{f}=100 fine classes. This may provide a good compromise between performance and training/inference speed. The coarse and fine prototypes may be randomly initialized by the training module 404 at the beginning of the training. The training module 404 may train the ppNeSF module using a scale invariant depth loss with supervision from monocular depth estimation models. Note that using depth geometric priors is not necessary on small scale scenes. Resulting segmentations after training are displayed in FIG. 18.

FIG. 18 includes, left to right, an original image, a rendered depth, coarse image based segmentation

$${s}_{c}^{2 d} ,$$

fine image based segmentation

$$s {2}_{f}^{d} ,$$

coarse rendered segmentation

$${s}_{c}^{3 d} ,$$

fine rendered segmentation

$${s}_{f}^{3 d} ,$$

coarse uncertainty map

$${u}_{c}^{2 d} ,$$

and fine uncertainty map

$${u}_{f}^{2 d} .$$

The rendered and image based segmentation are well aligned, which allows for precise VL.

After training, for VL, as discussed above (e.g., FIGS. 2A-3), given a query image with an unknown pose of the camera that captured the query image, an initial pose P0 may be estimated using image retrieval, (e.g., the pose of the closest database image based on global descriptor similarities). From the initial pose, a randomly sampled set of pixels may be selected, and segmentation labels s^{3D} are rendered by the ppNeSF module while 2D segmentation labels s^{2D} are extracted from the query image by the 2D image encoder module 1712. The location and pose module 110 then minimizes cross entropy with regard to the pose, such as using the equation

$${min}_{P ∈ S E ( 3 )} {\sum }_{i = 1}^{N} {\sum }_{k = 1}^{K} {s}_{m}^{2 D} ( k \vert {u}_{i} ) log ( s {m}_{3 D}^{} ( k \vert {u}_{i} ) )$$

with m∈{c, f} being the segmentation level (coarse or fine) and

$${s}_{m}^{2 D} , {s}_{m}^{2 D}$$

are the softmax of the segmentation logits. The logits can also be first weighted with sampled uncertainty as described below. By backpropagating through the implicit model, the pose is updated by the location and pose module 110 and the optimization process is iteratively repeated for a fixed number of iterations. This process is sequentially repeated for the coarse and the fine segmentation as to increase the convergence basin of the pose estimation.

The ppNeSF systems and methods describe herein not only outperform other privacy-preserving methods but remains competitive even with non privacy-preserving alternatives.

In the following, first will be provided additional information about ppNeSF, including more details regarding the hierarchical scheme and uncertainty computation.

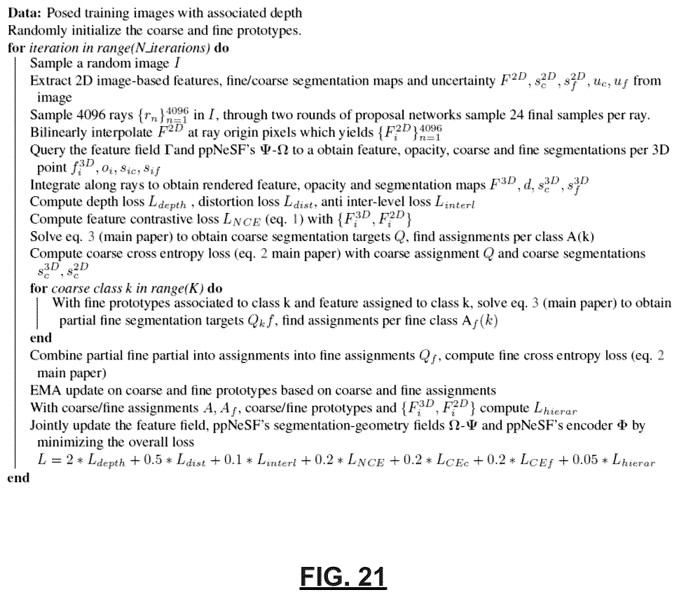

Pseudo-code for an example of training of the ppNeSF module is provided in FIG. 21.

Regarding the fine segmentation level of the hierarchical approach, a finer supervision to ppNeSF is provided and increases the convergence basin during visual localization. For each coarse class k∈[1, K], a mapping is established between the assigned features A(k) to coarse class k and the n fine prototypes associated to class k. Let K_{f}=n*K be the total number of fine prototypes and U the number of pixels in the training batch. The training module 404 may first compute softmax scores from the similarities between 3D features and 3D fine prototypes

$${\{ {p}_{f k}^{3 D} \}}_{k = 1}^{n}$$

and the similarities between 2D features and 2D fine prototypes

$${\{ {p}_{fk}^{2 D} \}}_{k = 1}^{n} .$$

Subsequently, for a coarse class k, the equation above with S^{f}∈ [symbol] ^{|A(k)|n} defined as

$$\frac{{S}_{ik}^{f} = exp ( \frac{{F}_{i}^{2 D} {p}_{fk}^{2 d}}{{τ}_{2}} ) exp ( \frac{{F}_{i}^{3 D} {p}_{fk}^{3 d}}{{τ}_{2}} )}{Z}$$

yielding

$${Q}_{k}^{f} ∈ {ℝ}^{\vert A ( k ) \vert n} ,$$

with Z being a predetermined normalization factor. The K resulting mapping

$${Q}_{k}^{f}$$

are combined into Qf∈ [symbol] ^{UK}^{_{f}} which is used by the training module 404 as segmentation target to optimize the overall training objective (equation (Y) with regard to the image encoder module φ 1712 and the segmentation/geometry fields modules Ω/ψ 1704 and 1708. Note that with this hierarchy constraint, Qf is not a minimizer of equation (Y) for the fine feature/prototypes similarity softmax score but still provides coherent and valid target labels. Fine assignments are defined as Af(k)={i|h(i)=k} with h=argmaxk(Q^{f}).

The fine prototypes are updated in the EMA by the training module 404 based on fine assignments, similar to the update of the coarse prototypes. In the embedding space, the hierarchy that was defined through the aforementioned hierarchical clustering algorithm is enforced. To that end the training module 404 trains the ppNeSF module based on (e.g., minimizing) the following hierarchical prototype loss.

$${L}_{hierar} = \frac{1}{2} {\sum }_{k = 1}^{K} \frac{1}{\vert A ( k ) \vert} {\sum }_{i ∈ A ( k )} {L}_{ick} + {\sum }_{k = 1}^{{K}_{f}} \frac{1}{\vert {A}_{f} ( k ) \vert} {\sum }_{i ∈ {A}_{f} ( k )} {〚 max ( L 〛}_{ifk} , {{max}_{j ∈ A ( {k}^{c} )} 〚 max ( L 〛}_{{jck}^{c}} ) )$$

here L_{ick} and L_{ifk} are the pixel to prototype contrastive losses at coarse (c) and fine level (f), with

$${L}_{ick} = - log ( \frac{exp ( \frac{{F}_{ui} {p}_{ck}}{τ} )}{{\sum }_{j = 1}^{N} exp ( \frac{{F}_{ui} {p}_{ck}}{τ} )} ) and {L}_{ifk} = - log ( \frac{exp ( \frac{{F}_{ui} {p}_{cfk}}{τ} )}{{\sum }_{j = 1}^{N} exp ( \frac{{F}_{ui} {p}_{fk}}{τ} )} ) .$$

For simplicity, the 2D/3D notations are omitted, but the loss is independently applied on 2D feature/prototypes and 3D feature/prototypes. Note that the k^{c} coarse prototypes are associated to the fine prototypes k and minimizing these distances between pixels and their assigned prototypes ensures that the loss between each pixel and its corresponding fine prototype remains below the loss with the associated coarse prototype.

The training module 404 models uncertainty using an uncertainty prediction head (module) so that the encoder module 1712 predicts both segmentation logits l∈R^{KWH} and class-wise uncertainties u∈R^{KWH} for each pixel. In this formulation, the training module 404 determines a per pixel Gaussian distribution over the segmentation classes, where the vector of logits lᵢ is the mean and the vector of uncertainties uᵢ is the diagonal elements of the covariance matrix. The cross entropy (loss) objective above is therefore modified by sampling the Gaussian distribution before applying softmax. This yields:

$${s}^{2 D} ( k \vert {u}_{i} ) = softmax ( {mean}_{t} ( {\{ {l}_{i}^{2 D} + {u}_{i} * {ϵ}_{t} \}}_{1}^{{N}_{S}} ) )$$

$${s}^{3 D} ( k \vert {u}_{i} ) = softmax ( {mean}_{t} ( {\{ {l}_{i}^{3 D} + {u}_{i} * {ϵ}_{t} \}}_{1}^{{N}_{S}} ) )$$

where Eₜ˜N(0,l) is jointly sampled N_{S} times for the 2D and 3D logits so that both modalities benefit from the uncertainty modelling. This allows for better stability during training and uncertainty is used to filter out ambiguous pixels during VL.

The number of latent segmentation classes has an impact. Based on the training dataset, different numbers of classes may be used. For example, for some training datasets at least 100 classes may be used, while for other training datasets at least 50 classes may be used. Above these minimum number of classes, accuracy may increase at a marginal rate. For a small number of classes, VL accuracy may be poor meaning that a minimum number of classes is required to provide sufficient discriminativeness. Overall, the number of classes may be scene-dependent and be set based on complexity of the scene.

The architecture of the ppNeSF module will now be discussed. The image based encoder module 1712 φ includes a feature backbone module 1712 and a decoder module 1732. The backbone may be a SWIN-t transformer backbone, such as described in Z. Liu, et al., Swin Transformer: Hierarchical Vision Transformer using Shifted Windows, in ICCV, 2021, which is incorporated herein in its entirety. In various implementations, the SWIN-t transformer backbone may be used with the following example parameters, patch size: 2, embed dim: 96, depths: {2, 2, 6, 2}, num heads={3, 6, 12, 24}). This may output a set of 4 feature maps with strides (2, 4, 8, 16). The feature map with stride 2 has a dimension of 96. It is processed through a feature head (module) 1740 including three conv2D layers (e.g., with internal dimension 128) with ReLU activation and one upsampling layer such that the feature map is pixel aligned. This resulting feature map has a dimension of 96 and is used for the joint embedding space learning. The multi-scale feature maps are processed with a convolutional feature pyramid type of network to output two final feature maps (e.g., of stride 4 and 2) that are processed through segmentation heads (e.g., including three conv2D layers with ReLU activation and internal dimension of, for example, 128, one upsampling layer, for example, of scale 4 or 2) which yield the pixel aligned coarse and fine segmentation maps with respectively K and K_{f} classes. An example of the convolutional feature pyramid type of network is described in T. Lin, et al., Feature Pyramid networks for Object Detection, in CVPR, 2017, which is incorporated herein in its entirety.

Similarly, these final feature maps are processed through the uncertainty heads (e.g., with three conv2D layers with ReLU activation and internal dimension of, for example, 128, one upsampling layer of, for example scale 4 or 2) to obtain the pixel aligned coarse and fine uncertainty maps with respectively K and K_{f} dimensions. The gradients are detached from the input of the feature head, coarse and fine uncertainty heads as to not destabilize the segmentation representation learning. No pre-trained weights are used by the training module 404 to initialize the encoder module 1712.

The feature field module Γ 1716 includes hash tables with (e.g., 10) levels with resolution ranging from, for example, 16 to 16384. The feature dimension per level is set to, for example, 4 with a log hashmap size of 21. A conical section of a ray includes for example 6 points and is encoded through the hash tables, and the encoded features are weighted and averaged by the feature field module 1716. This encoding makes the 3D feature scale aware which is beneficial for scene with large viewpoint changes. The resulting feature is then concatenated with the scale feature and processed by a MLP (multilayer perceptron) including 3 linear layers (e.g., internal dimension 128) with ReLU activations. The output feature may have a dimension of 96 to match with the encoder-based feature dimension. Feature rendering of the rendering module 1724 uses the opacity weight from the main neural implicit field, and gradients are detached from these weights.

A neural implicit field is a representation of a 3D scene whose underlying geometry is encoded through MLPs. Additional information such as radiance, semantics or features may also be stored and encoded. NeRFs are a form of neural implicit fields which store radiance and use volumetric rendering to optimize the neural fields solely using RGB images with known intrinsics and camera poses. Training efficiency may be increased by introducing 3D structures such as hash tables, octrees or grids, reducing the number of required training views by adding additional regularization or geometric priors, and improving the quality by reducing aliasing.

The ppNeSF module may use the ZipNerf architecture as the background neural implicit field, as discussed above. This can be described as, given an image with known pose, each emitted ray is modeled as canonical frustum whose sections can be decomposed into a set of (e.g., 6) isotropic Gaussians such that they approximate the shape of the conical frustum. For a canonical section, for each level Vₗ of the grid, a feature is obtained by trilinear interpolation applied at the Gaussian's mean location xⱼ. The six resulting features are reweighted w_{j,l} based on how each Gaussian fits into the grid cell and the averaged f_l= [symbol] mean [symbol] _j(w_(j,l) trilerp(x_j; V_l), trilerp being the trilinear interpolation operation. The resulting level features are then concatenated and fed into a shallow MLP to obtain the density and a geometric feature dᵢ, gᵢ=h_{geo}(cat[fₗ]l).

The geometric feature is fed along with the encoded point position to a shallow MLP to obtain the 3D segmentation

$${s}_{i}^{3 D} = {h}_{seg} ( cat [ g , enc ( pos ) ] ) .$$

This combination of multi-sampling and weighting effectively reduces spatial-aliasing and handles scale variations. Segmentations can be rendered by the rendering module 1724 through alpha composition

$${s}^{3 D} = {\sum }_{i = 1}^{n} {T}_{i} {α}_{i} {s}_{i}^{3 D}$$

where Tᵢ is the accumulated transmittance at sample i and α the discrete opacity value at sample i. Furthermore, Z-aliasing induced by the proposal sampling is handled by deriving an inter-level loss which is smooth with regard to translation along the ray.

Except for the segmentation part, the geometric field module ψ 1704 architecture includes two levels of proposal networks. Their hash tables' maximum resolutions may be, for example, are 512 and 2048. The main network uses a hash grid with, for example, 10 levels with resolution ranging from 16 to 16384. The feature dimension per level for all hash tables is set to, for example, 4 with a log hashmap size of, for example, 21. The geometric MLP of the geometric field module 1704 may include two linear layers and ReLU activations (e.g., internal dimension 64), scale featurization is used. The coarse and fine segmentation heads include a three layer MLP with ReLU activations (internal dimension of, for example, 128). The number of samples per proposal network is set to, for example, 48 while the number of samples for the main network is set to, for example, 24. Sampling is handled by the proposal networks.

Regarding hyperparameters, the training module 404 may train the ppNeSF module and the feature field module 1716 with a learning rate of initial learning rate of 1e-2 exponentially decaying to 1e-4, such as with the Adam optimizer. The training module 404 may train the encoder module 1712 with an initial learning rate of 1e-3 exponentially decaying to 1e-4 with Adam optimizer. The training module 404 may train for a predetermined number of iterations, such as 50,000 iterations per scene or another suitable number of iterations. The training module 404 may sample 4096 rays per training iteration or another suitable number of rays. Proposal weights may be annealed (e.g., fixed and held constant) by the training module 404 during a predetermined number of the iterations, such as 1000 iterations. Distortion (e.g., with a weight of 5) and anti-interlevel (e.g., with a weight of 0.1) losses may be used during training. Depth supervision with a depth loss (e.g., with a weight of 2.) is used by the training module 404 to give a coarse geometry prior to our models.

After training during VL, during the pose refinement, 4096 rays or another suitable number of rays are sampled per iteration on some datasets and 8192 rays or another suitable number of rays are sampled other datasets. 64 proposal samples per ray and 32 final samples per ray may be used. Pose may be refined for 150 coarse iterations and 150 fine iterations or another suitable number of coarse and/or fine iterations. Some query images may involve more iterations when the optimization landscape is not smooth. The pose is optimized on SE(3). Optimization is performed, for example, with the Adam optimizer, decay rate is set to, for example, 0.33, initial learning rate is set to, for example, 2e-2. A baseline performing pose refinement may be performed by aligning RGB images rendered with ZipNeRF to the query images.

Regarding inversion attack training, for each training epoch of the inversion model, the training module 404 may randomly select a scene along with a NIF trained on that scene (note that the NIF is then frozen as only the inversion model is trained). For each iteration, the training module 404 may select a viewpoint with an associated image. On the rays emerging from this camera viewpoint, the training module 404 may sample point and internal representations from the implicit model are extracted. These representations are then rendered by the rendering module 1724 by alpha composition using the opacity weights of the implicit model. The rendered internal representations are fed to the inversion network which attempts to reconstruct the grayscale GT image by minimizing a combination of L1 loss and perceptual LPIPS loss. The training module 404 may learn to reconstruct the grayscale images—instead of RGB—to increase the generalization power of the model across datasets and to make the model robust to color variations of certain objects.

A UNET architecture may be used in various implementations for the inversion module. The UNET architecture is described in O. Ronneberger, et al., U-Net: Convolutional Networks for Biomedical Image Segmentation, 2015, which is incorporated herein in its entirety. This architecture takes as input feature maps and outputs one channel grayscale reconstructed images. includes six encoding blocks/modules (each including the following layers: Reflectionpad2D, conv2D, Batchnorm2D and ReLU activation), six decoding blocks/modules (each including the following layers: Upsample, Reflectionpad2D, conv2D, Batchnorm2D and ReLU activation) of four refinement blocks/modules (each including following layers: Reflectionpad2D, conv2D, Batchnorm2D and ReLU activation or sigmoid activation and no batchnorm for the last block). Internal dimensions of encoders are, for example, 256, 256, 256, 512, 512, 512, internal dimensions of decoder blocks are, for example, 512, 512, 512, 256, 256, 256, internal dimensions are refinement blocks are, for example, 128, 64, 32, 1. In various implementations, the encoder blocks conv2d kernel size is 4, the encoder blocks conv2d kernel size is 3, although other suitable sizes may be used. Skip connections may be used for the decoder blocks.

The inversion model may be trained using the Adam optimizer. The initial learning rate may be set to set to, for example, 1e-3 and weight decay set to, for example, 1e-4. The training module 404 may train the inversion module for 50 epochs and each epoch containing 100 rendering iterations with a batch size of 2, although other suitable number of epochs, rendering iterations, and/or batch sizes may be used. The scene may be changed (and the associated implicit model trained on the same scene) once every epoch and the learning rate decays once every epoch. The set of scenes used for training one inversion model belong to the same dataset.

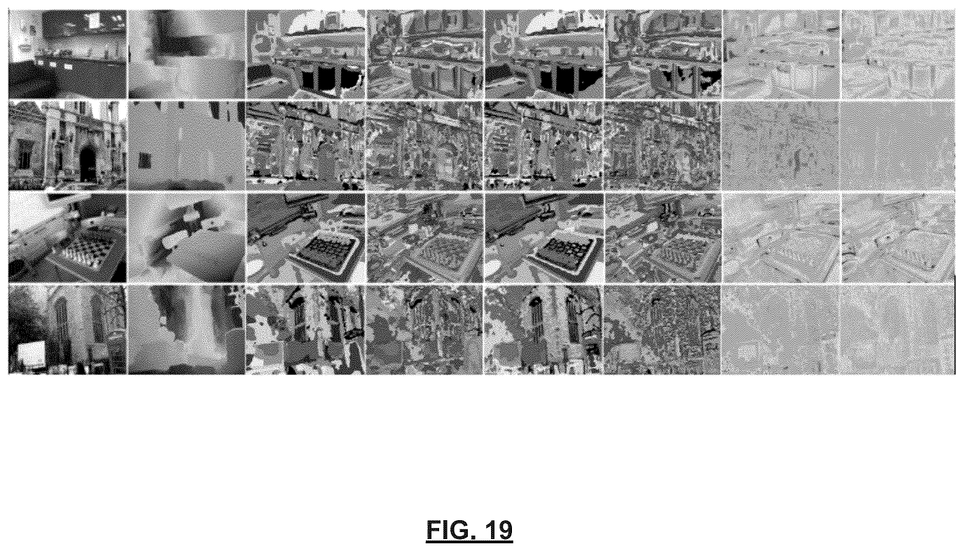

FIG. 19 includes example images. Left to right in FIG. 19 include original images, rendered depth maps, coarse image based segmentations (maps)

$${s}_{c}^{2 D} ,$$

fine image based segmentations (maps)

$${s}_{f}^{2 D} ,$$

coarse rendered segmentation (maps)

$${s}_{c}^{3 D} ,$$

fine rendered segmentations (maps)

$${s}_{f}^{3 D} ,$$

coarse uncertainty map

$${u}_{c}^{2 D}$$

(each pixel representing an uncertainty of the corresponding pixel in the coarse rendered segmentation), and fine uncertainty map

$${u}_{f}^{2 D}$$

(each pixel representing an uncertainty of the corresponding pixel in the fine rendered segmentation).

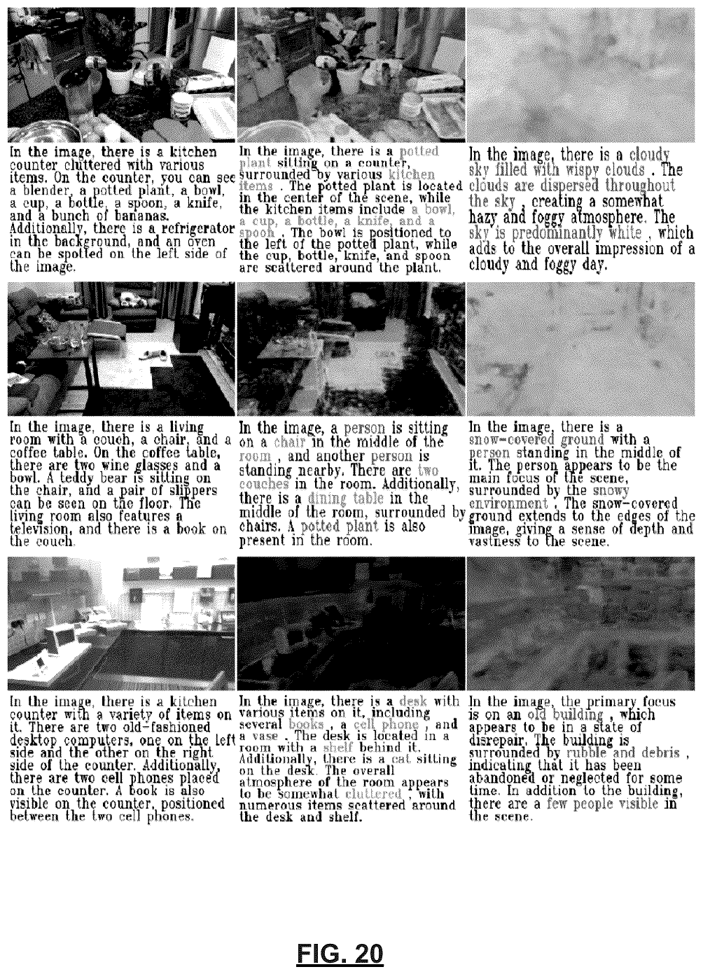

FIG. 20 includes example images. From left to right in FIG. 20 includes ground truth images, images reconstructed by a different architecture (ZipNerf without RGB) after an inversion attack, and images reconstructed from the ppNeSF with an inversion attack. FIG. 20 illustrates privacy preserved by the ppNeSF module described herein. Objects correctly identified are illustrated by green text, while red text illustrates improper identifications (hallucinations).

As discussed above, FIG. 21 includes an example algorithm for training of the ppNeSF module.

Line 1 involves randomly initializing the coarse/fine prototypes.

Line 3 involves sampling a random training image with its pose.

Line 4 involves extracting image features, segmentations (coarse/fine) and uncertainties (coarse/fine) from the encoder module 1712.

Line 5 involves sampling 3D points on rays emanating from the current training pose.

Line 6 involves collecting features at 2D ray origins from the extracted image features.

Line 7 involves extracting features/opacity/segmentations (coarse/fine) at 3D points locations from the feature/geometry/segmentation fields 1716/1704/1708.

Line 8 involves rendering 3D features/opacity/segmentations (coarse/fine).

Line 9 involves computing regularization losses.

Line 10 involves computing the contrastive loss.

Line 11 involves deriving coarse segmentation targets.

Line 12 involves computing the coarse cross-entropy loss using coarse segmentation targets as pseudo ground truth.

Line 13-15 involve computing fine segmentation targets for each coarse class.

Line 16 involves concatenating the fine segmentation targets in a single matrix and using it as pseudo ground truth to compute the fine cross-entropy loss.

Line 17 involves updating the fine/coarse prototypes with an EMA scheme.

Line 18 involves computing the hierarchical prototypical loss.

Line 19 involves involves backpropagating gradients from the global loss (weighted summation of individual losses) with respect to modules 1716/1704/1708.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. A method for performing privacy-preserving visual localization, by a computing device, using a two dimensional (2D) query image captured by a camera, comprising:
(a) determining a query segmentation map based on the query image, wherein each pixel of the query segmentation map is associated with one or more likelihoods that it belongs to one or more segmentation classes that are scene-specific and learned in a self-supervised manner;
(b) accessing a privacy preserved scene representation that includes labeled three dimensional (3D) representations of a scene selected from the one or more segmentation classes, the privacy preserved scene representation comprising one or more of:
(i) a 3D point cloud generated by Structure-from-Motion (SfM);
(ii) a neural implicit field including a neural radiance field (NeRF) and/or associated geometric, segmentation and/or feature fields; and
(iii) a Gaussian Splatting Feature Field (GSFF) including a plurality of 3D Gaussian primitives;
(d) determining a predicted pose based on a starting pose; and
(e) generating, from the predicted pose, a predicted segmentation map;
(f) refining the predicted pose after aligning the predicted segmentation map with the query segmentation map, each of the query segmentation map and the predicted segmentation map including for each pixel one or more likelihoods that it belongs to the one or more segmentation classes, respectively;
(g) repeating the generating and the refining until the query segmentation map and the predicted segmentation map converge to within a predefined convergence criterion;
(h) outputting the refined predicted pose of the query image captured by the camera using the predicted segmentation map at (g) that converged to within the predicted convergence criterion.

2. The method of claim 1 wherein the privacy preserved scene representation is generated from a set of training images representing the scene using one or more of (i) Structure-from-Motion (SfM) (ii) Neural Radiance Fields (NeRFs) and (iii) Gaussian Splatting Feature Fields (GSFF).

3. The method of claim 2 further comprising generating (i) a global descriptor of the input image, and (ii) global descriptors with pose information of the set of training images representing the scene, each global descriptor aggregating image features into a single descriptor.

4. The method of claim 3 wherein the starting pose is predicted based on similarities between the global descriptor for the query image and the global descriptors for the set of training images.

5. The method of claim 1 wherein the privacy preserved scene representation includes labeled three dimensional (3D) representations of the scene (i) with texture and/or fine details obscured and (ii) from which views of the scene may be rendered.

6. The method of claim 1, wherein, when the privacy-preserved scene representation corresponds to the 3D point cloud generated by SfM, the 3D point cloud includes 3D points labeled by the one or more segmentation classes, wherein the one or more segmentation classes are derived in a self-supervised manner using pixel correspondences.

7. The method of claim 1, wherein, when the privacy-preserved scene representation corresponds to the neural implicit field, the neural implicit field comprises:
a segmentation field module configured to provide segmentation information on the scene in the training images; and
a geometric field module configured to provide geometric information on the scene;
wherein the neural implicit field is trained using segmentation labels as supervision such that high-frequency texture details are suppressed, and an internal representation of the scene is privacy-preserving.

8. The method of claim 7, wherein the neural implicit field comprises a feature field module configured to provide feature information on the scene.

9. The method of claim 1, wherein, when the privacy-preserved scene representation corresponds to the GSFF, the GSFF comprises one or more 3D Gaussian primitives each having a center, a covariance, an opacity and a feature or segmentation label, wherein images are rendered by rasterizing the one or more 3D Gaussian primitives using depth ordering and alpha blending.

10. The method of claim 2, further comprising:
generating a global descriptor of the query image;
accessing global descriptors with pose information of the set of training images representing the scene; and
determining the starting pose based on similarities between the global descriptor for the query image and the global descriptors for the training images.

11. The method of claim 10, wherein:
the query segmentation map comprises segmentation heatmaps;
the global descriptor is generated by applying a pooling operator to the segmentation heatmaps; and
selecting the starting pose includes selecting k images based on similarities between the global descriptor for the query image and global descriptors of the k images, respectively.

12. The method of claim 1 wherein the aligning is performed using all pixels of the query segmentation map or only a subset of pixels of the query segmentation map.

13. The method of claim 1 wherein the one or more segmentation classes define a non-injective mapping from RGB pixels or features to labels such that regions of the scene having different texture details share a same segmentation label to suppress retrieval of sensitive visual details.

14. The method of claim 1, further comprising:
determining a location in the scene using the refined predicted pose output at (h); and
performing, with the computing device, one or more tasks using the determined location;
wherein the one or more tasks are tailored to the location and include one or more of an auditory response concerning the location, a delivery to the location, and navigation to the location.

15. The method of claim 14, wherein the computing device is one of a robot and a virtual assistant.

16. A system that performs visual localization using a two dimensional (2D) query image captured by a camera, the system comprising:
at least one processor;
at least one memory, wherein executable instructions stored in the at least one memory are configured to cause the at least one processor to:
(a) determine a query segmentation map based on the query image, wherein each pixel of the query segmentation map is associated with one or more likelihoods that it belongs to one or more segmentation classes that are scene-specific and learned in a self-supervised manner;
(b) access a privacy preserved scene representation that includes labeled three dimensional (3D) representations of a scene selected from one or more segmentation classes, the privacy preserved scene representation comprising one or more of;
(i) a 3D point cloud generated by Structure-from-Motion (SfM);
(ii) a neural implicit field including a neural radiance field (NeRF) and/or associated geometric, segmentation and/or feature fields; and
(iii) a Gaussian Splatting Feature Field (GSFF) including a plurality of 3D Gaussian primitives;
(d) determine a predicted pose based on a starting pose; and
(e) generate from the predicted pose a predicted segmentation map;
(f) refine the predicted pose after aligning the predicted segmentation map with the query segmentation map, each of the query segmentation map and the predicted segmentation map including for each pixel one or more likelihoods that it belongs to the one or more segmentation classes, respectively;
(g) repeat the generating and the refining until the query segmentation map and the predicted segmentation map converge to within a predefined convergence criterion;
(h) output the refined predicted pose of the query image captured by the camera using the predicted segmentation map at (g) that converged to within the predicted convergence criterion.

17-19. (canceled)

20. The system of claim 16, wherein the executable instructions stored in the at least one memory are further configured to cause the at least one processor to:
determine a location in the scene using the refined predicted pose output at (h); and
perform one or more tasks using the determined location;
wherein the one or more tasks are tailored to the location and include one or more of an auditory response concerning the location, a delivery to the location, and navigation to the location.

21. A training system for privacy preserving visual localization, comprising:
a pose module configured to receive training images captured using a camera and determine a six degrees of freedom (6 DoF) pose of the camera that captured each of the training images;
an encoder module including a segmentation module configured to determine at least one segmentation heatmap and at least one global descriptor based on an input image;
a scene-representation module configured to provide a privacy-preserved scene representation of a scene viewed in the training images, the scene-representation module being configured to implement one or more of:
a 3D point cloud generated by Structure-from-Motion having labeled 3D points;
a neural implicit field including a segmentation field module providing segmentation information, a geometric field module providing geometric information; and
a Gaussian Splatting Feature Field including 3D Gaussians each having a center, covariance, opacity, and feature or segmentation label; and
a training module configured to:
input the training images to the pose module;
determine prototype distributions or prototypes in a feature embedding space based on feature maps or volumetric features derived from the training images and the privacy-preserved scene representation; and
train at least the segmentation module and at least one of the pose module, the scene-representation module, the segmentation field module, and the geometric field module, by alternating between:
(i) updating a target distribution with parameters of the segmentation module fixed based on minimizing a first loss determined using a label distribution determined from the prototypes;
(ii) updating parameters of the segmentation module with the target distribution fixed based on minimizing a second loss that is different from the first loss; and
(iii) updating parameters of the segmentation module and/or the pose module based on a ranking loss using a global representation.

22. The training system of claim 21, wherein the second loss is a per-pixel cross-entropy loss between predicted segmentation heatmaps and pseudo-labels.

23. The training system of claim 21, wherein the training module is configured to train the segmentation module based on a first function based on feature vectors and prototype distributions during a first epoch of a predetermined number of epochs and a second function different from the first function during remaining epochs.

24. The training system of claim 21, wherein the training module is configured to train the pose module further based on minimizing a consistency loss, the consistency loss being determined based on at least one of:
labels assigned to keypoints in the training images based on distances to the prototype distributions; and
feature maps determined based on the training images.

25. The training system of claim 21, wherein the training module is further configured to train the segmentation module based on minimizing a contrastive loss determined based on the prototype distributions, feature maps, and concentrations of the prototype distributions.

26. The training system of claim 21, wherein the ranking loss comprises a multi-similarity loss applied to at least one global descriptor derived from the training images.

27. The training system of claim 21, wherein, when the scene-representation module implements the Gaussian Splatting Feature Field, the training module is further configured to:
cause a rasterization module to render a second feature map and a second segmentation map aligned with a first feature map and a first segmentation map extracted by the encoder module; and
train parameters of the encoder module based on at least one loss determined based on at least one of:
a difference between the first feature map and the second feature map; and
a difference between the first segmentation map and the second segmentation map.

28. The training system of claim 27, wherein the training module is further configured to:
apply spectral clustering on a Delaunay graph derived from a Gaussian cloud to produce a set of prototypes; and
generate labels for respective 3D Gaussians of the Gaussian cloud by assigning volumetric features to the prototypes.

29. The training system of claim 21, wherein, when the scene-representation module implements the neural implicit field with segmentation, the training module is configured to:
generate a first set of K prototypes based on features extracted from an input image;
generate a second set of K prototypes based on segmentation information, geometric information, and feature information produced by the segmentation field module, and the geometric field module;
align the first and second sets of K prototypes and determine segmentation targets based on mapping features to the prototypes based on similarities in the feature embedding space; and
jointly train the encoder module, the segmentation field module, and the geometric field module, using a cross-entropy loss based on the segmentation targets,
wherein K is an integer greater than zero and corresponds to a predetermined number of segmentation classes.

30. A training method for privacy-preserving visual localization, the method comprising:
receiving, by a pose module executed by at least one processor, training images captured using a camera;
determining, by an encoder module including a segmentation module executed by the at least one processor, at least one segmentation heatmap and at least one global descriptor based on an input image;
providing, by a scene-representation module executed by the at least one processor, a privacy-preserved scene representation of a scene viewed in the training images, the scene-representation module implementing one or more of:
a 3D point cloud generated by Structure-from-Motion having labeled 3D points;
a neural implicit field including a segmentation field module providing segmentation information and a geometric field module providing geometric information; and
a Gaussian Splatting Feature Field including 3D Gaussians each having a center, covariance, opacity, and feature or segmentation label;
determining, by a training module executed by the at least one processor, prototype distributions or prototypes in a feature embedding space based on feature maps or volumetric features derived from the training images and the privacy-preserved scene representation; and
training, by the training module, at least the segmentation module and at least one of the pose module, the scene-representation module, the segmentation field module, and the geometric field module, by alternating between:
(i) updating a target distribution with parameters of the segmentation module fixed based on minimizing a first loss determined using a label distribution determined from the prototypes;
(ii) updating parameters of the segmentation module with the target distribution fixed based on minimizing a second loss that is different than the first loss; and
(iii) updating parameters of the segmentation module and/or the pose module based on a ranking loss using the global descriptor.

31-33. (canceled)

34. The training method of claim 30, wherein determining the prototype distributions includes rejecting outlier feature vectors based on a distance threshold relative to a cluster center associated with one of the prototypes.

35. The training method of claim 30, further comprising storing, in a memory, intermediate prototype distributions generated during earlier epochs and reusing the intermediate prototype distributions for stabilizing later iterations of the training.

36-37. (canceled)

38. The training method of claim 30, further comprising generating confidence values for respective segmentation classes based on (i) distances to respective prototypes or (ii) learning, and applying the confidence values during training and inference.

39-120. (canceled)
